(19) United States
(12) Patent Application Publication
(10) Pub. No.: US 2026/0223184 A1
(43) Pub. Date: Jul. 30, 2026

(54) CONTENTION FREE RANDOM ACCESS FOR INTRA-CELL MULTIPLE TRANSMISSION AND RECEPTION POINTS

(71) Applicant: QUALCOMM Incorporated, San Diego, CA (US)

(72) Inventors: Shaozhen GUO, Beijing (CN); Mostafa KHOSHNEVISAN, San Diego, CA (US)

(21) Appl. No.: 19/143,674

(22) PCT Filed: Feb. 23, 2024
(86) PCT No.: PCT/CN2024/078286

§ 371 Date: Jun. 26, 2025

(30) Foreign Application Priority Data
Feb. 27, 2023 (WO) PCTCN2023078351

(51) Int. Cl. H04W 74/0833; H04L 5/00; H04W 52/24; H04W 72/23

(52) U.S. Cl. CPC H04W 74/0833; H04L 5/0053; H04W 52/242; H04W 72/23

(57) ABSTRACT

Various aspects of the present disclosure generally relate to wireless communication. In some aspects, a user equipment (UE) may receive a configuration for a first control resource set (CORESET) pool index value, a second CORESET pool index value, and two timing advance groups on a serving cell. The UE may receive a physical downlink control channel (PDCCH) order associated with the first CORESET pool index value associated with a serving physical cell identifier (PCI) and indicating a physical random access channel (PRACH) communication. The UE may transmit the PRACH communication associated with the first CORESET pool index value or the second CORESET pool index value associated with the serving PCI in accordance with the PDCCH order. Numerous other aspects are described.

### CROSS-REFERENCE TO RELATED APPLICATION

This Patent Application claims priority to International Patent Application No. PCT/CN 2023/078351, filed on Feb. 27, 2023, entitled “CONTENTION FREE RANDOM ACCESS FOR INTRA-CELL MULTIPLE TRANSMISSION AND RECEPTION POINTS” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for contention free random access for intra-cell multiple transmission and reception points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for a first control resource set (CORESET) pool index value, a second CORESET pool index value, and two timing advance groups on a serving cell. The method may include receiving a physical downlink control channel (PDCCH) order associated with the first CORESET pool index value associated with a serving physical cell identifier (PCI) and indicating a physical random access channel (PRACH) communication. The method may include transmitting the PRACH communication associated with the first CORESET pool index value or the second CORESET pool index value associated with the serving PCI in accordance with the PDCCH order.

Some aspects described herein relate to a method of wireless communication performed by a network node. The method may include outputting, to a UE, a configuration for a first CORESET pool index value, a second CORESET pool index value, and two timing advance groups on a serving cell. The method may include outputting, to the UE, a PDCCH order associated with the first CORESET pool index value associated with a serving PCI and indicating a PRACH communication. The method may include receiving the PRACH communication output by the UE associated with the first CORESET pool index value or the second CORESET pool index value of the serving PCI.

Some aspects described herein relate to a UE for wireless communication. The UE may include one or more memories and one or more processors coupled to the one or more memories. The one or more processors may be configured to receive a configuration for a first CORESET pool index value, a second CORESET pool index value, and two timing advance groups on a serving cell. The one or more processors may be configured to receive a PDCCH order associated with the first CORESET pool index value associated with a serving PCI and indicating a PRACH communication. The one or more processors may be configured to transmit the PRACH communication associated with the first CORESET pool index value or the second CORESET pool index value associated with the serving PCI in accordance with the PDCCH order.

Some aspects described herein relate to a network node for wireless communication. The network node may include one or more memories and one or more processors coupled to the one or more memories. The one or more processors may be configured to output, to a UE, a configuration for a first CORESET pool index value, a second CORESET pool index value, and two timing advance groups on a serving cell. The one or more processors may be configured to output to the UE, a PDCCH order associated with a first CORESET pool index value associated with a serving PCI and indicating a PRACH communication. The one or more processors may be configured to receive the PRACH communication output by the UE associated with the first CORESET pool index value or the second CORESET pool index value of the serving PCI.

Some aspects described herein relate to a non-transitory computer-readable medium that stores a set of instructions for wireless communication by a UE. The set of instructions, when executed by one or more processors of a UE, may cause the UE to receive a configuration for a first CORESET pool index value, a second CORESET pool index value, and two timing advance groups on a serving cell. The set of instructions, when executed by one or more processors of the UE, may cause the UE to receive a PDCCH order associated with a first CORESET pool index value associated with a serving PCI and indicating a PRACH communication. The set of instructions, when executed by one or more processors of the UE, may cause the UE to transmit the PRACH communication associated with the first CORESET pool index value or the second CORESET pool index value associated with the serving PCI in accordance with the PDCCH order.

Some aspects described herein relate to a non-transitory computer-readable medium that stores a set of instructions for wireless communication by a network node. The set of instructions, when executed by one or more processors of the network node, may cause the network node to output, to a UE, a configuration for a first CORESET pool index value, a second CORESET pool index value, and two timing advance groups on a serving cell. The set of instructions, when executed by one or more processors of the network node, may cause the network node to output, to the UE, a PDCCH order associated with a first CORESET pool index value associated with a serving PCI and indicating a PRACH communication. The set of instructions, when executed by one or more processors of the network node, may cause the network node to receive the PRACH communication output by the UE associated with the first CORESET pool index value or a second CORESET pool index value of the serving PCI.

Some aspects described herein relate to an apparatus for wireless communication. The apparatus may include means for receiving a configuration for a first CORESET pool index value, a second CORESET pool index value, and two timing advance groups on a serving cell. The apparatus may include means for receiving a PDCCH order associated with the first CORESET pool index value associated with a serving PCI and indicating a PRACH communication. The apparatus may include means for transmitting the PRACH communication associated with the first CORESET pool index value or the second CORESET pool index value associated with the serving PCI in accordance with the PDCCH order.

Some aspects described herein relate to an apparatus for wireless communication. The apparatus may include means for outputting, to a UE, a configuration for a first CORESET pool index value, a second CORESET pool index value, and two timing advance groups on a serving cell. The apparatus may include means for outputting, to a UE, a PDCCH order associated with the first CORESET pool index value associated with a serving PCI and indicating a PRACH communication. The apparatus may include means for receiving the PRACH communication output by the UE associated with the first CORESET pool index value or the second CORESET pool index value of the serving PCI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network, in accordance with the present disclosure.

FIG. 5 is a diagram illustrating an example of multiple transmission and reception point (mTRP) communication in accordance with the present disclosure.

FIG. 6 is a diagram illustrating an example of TRP differentiation at a UE based at least in part on a control resource set pool index, in accordance with the present disclosure.

FIGS. 7A-7C are tables illustrating examples of intra-cell mTRP, in accordance with the present disclosure.

FIG. 8 is a diagram illustrating an example associated with contention free random access for intra-cell mTRP, in accordance with the present disclosure.

FIG. 9 is a diagram illustrating an example associated with determining a demodulation reference signal antenna port quasi co-location property for a random access response (RAR), in accordance with the present disclosure.

FIGS. 10A-10F are diagrams illustrating examples associated with RAR windows, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

A user equipment (UE) may attempt a contention free random access (CFRA) procedure with a network node, such as a gNB, for various purposes such as timing advance (TA) acquisition, synchronizing network communications, beam failure recovery, handling system information requests, handovers to new network nodes, etc. In a CFRA procedure, the UE is assigned a preamble, which is included with random access communications to the network node.

Configuring a UE with multiple CORESET pool index values and multiple TA groups (TAGs) may allow the UE to participate in CFRA for inter-cell or intra-cell multi-transmission and reception point (mTRP) communications. However, CFRA inter-cell and intra-cell mTRP communications can present challenges. For example, for CFRA on a special cell (SpCell), the UE may be able to assume that the demodulation reference signal (DMRS) ports of the random access response (RAR) physical downlink control channel (PDCCH)/physical downlink shared channel (PDSCH) and the DMRS ports of the PDCCH order are quasi co-located (QCLed). That is not the case for CFRA on a secondary cell (SCell). For physical random access channel (PRACH) power control, the UE may be able to assume that a path loss reference signal (PL-RS) and reference signal power are based on a downlink reference signal (DL-RS) that the DMRS of a PDCCH order is QCLed with. Such a QCL relationship may not be valid in certain intra-cell mTRP implementations, however. In another example, the UE cannot receive a Type-1 common search space (CSS) from the network node with an additional active physical cell identifier (PCI).

Accordingly, without additional configurations or information, the UE may not be able to engage in a CFRA procedure in an intra-cell mTRP scenario involving an SCell, an SpCell, or both, because certain assumptions or configurations of the UE may be inapplicable to certain intra-cell mTRP communications.

Some techniques and apparatuses described herein enable the UE to receive a PDCCH order associated with a first control resource set (CORESET) pool index value associated with a serving PCI and indicating a PRACH communication; transmit the PRACH communication associated with the first CORESET pool index value or a second CORESET pool index value associated with the serving PCI in accordance with the PDCCH order; and monitor a RAR communication responsive to the PRACH communication and associated with the first CORESET pool index value or the second CORESET pool index value different from the first CORESET pool index value. As a result, the UE can be configured to engage in CFRA for intra-cell mTRP. For example, the UE can be configured to receive the RAR communication from a TRP with a different CORESET pool index than the CORESET pool index of the TRP that received the PRACH communication.

Some techniques and apparatuses described herein enable the network node to output or configure, to a UE, a PDCCH order associated with a first CORESET pool index value associated with a serving PCI and indicating a PRACH communication; receive the PRACH communication output by the UE associated with the first CORESET pool index value or a second CORESET pool index value of the serving PCI; and output or configure a RAR communication responsive to the PRACH communication and associated with the first CORESET pool index value or the second CORESET pool index value different from the first CORESET pool index value. As a result, the network node can configure the UE to communicate with multiple TRPs during the CFRA procedure while minimizing the impact of various conditions including non-ideal backhaul (NIB) delay.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

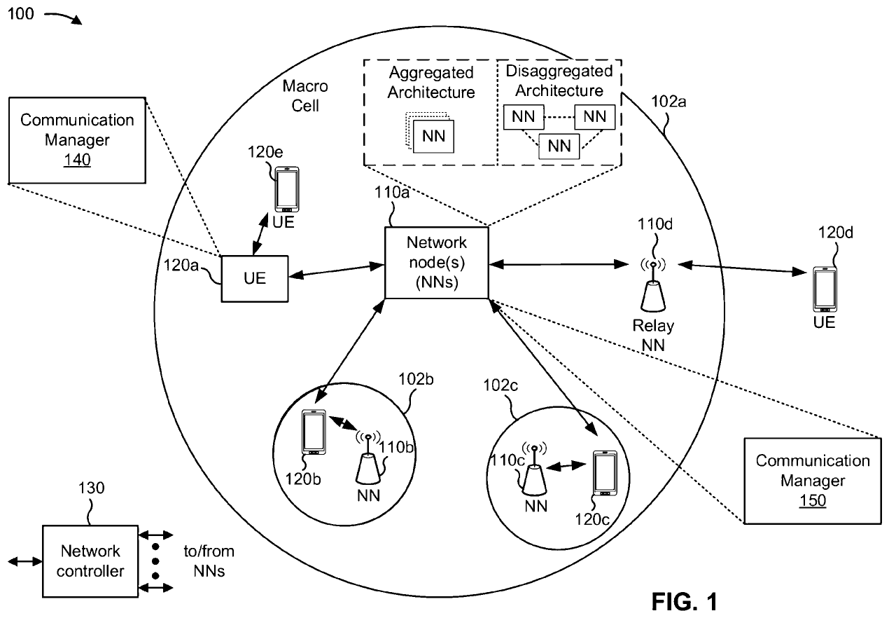

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for a first CORESET pool index value, a second CORESET pool index value, and two timing advance groups on a serving cell; receive a PDCCH order associated with the first CORESET pool index value associated with a serving PCI and indicating a PRACH communication; and transmit the PRACH communication associated with the first CORESET pool index value or the second CORESET pool index value associated with the serving PCI in accordance with the PDCCH order. Additionally, or alternatively, the communication manager 140 may perform one or more other operations described herein.

In some aspects, the network node 110 may include a communication manager 150. As described in more detail elsewhere herein, the communication manager 150 may output, to a UE 120, a configuration for a first CORESET pool index value, a second CORESET pool index value, and two timing advance groups on a serving cell; output, to the UE 120, a PDCCH order associated with a first CORESET pool index value associated with a serving PCI and indicating a PRACH communication; and receive the PRACH communication output by the UE 120 associated with the first CORESET pool index value or the second CORESET pool index value of the serving PCI. Additionally, or alternatively, the communication manager 150 may perform one or more other operations described herein.

As indicated above, FIG. 1 is provided as an example. Other examples may differ from what is described with regard to FIG. 1.

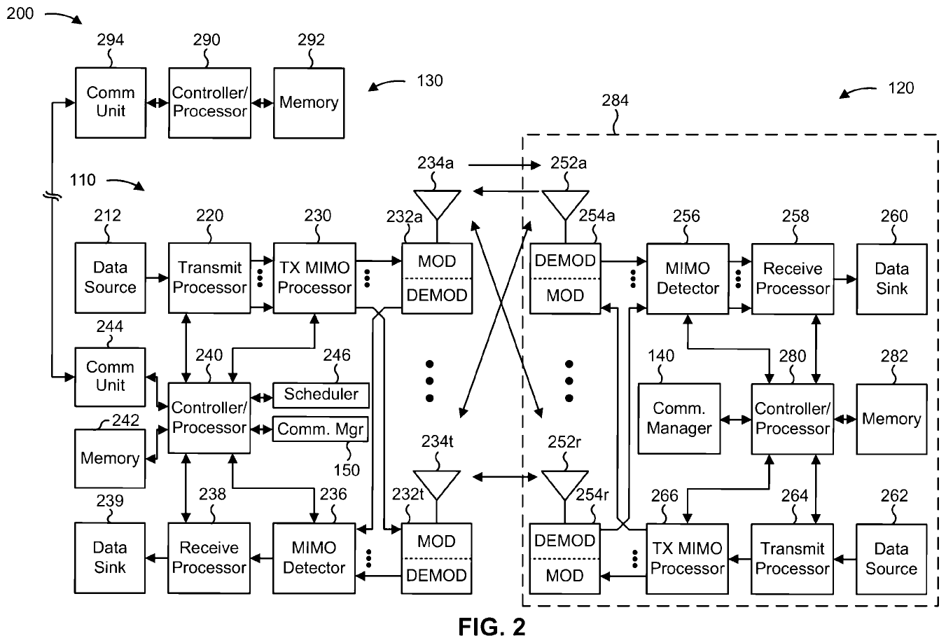

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a DMRS) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

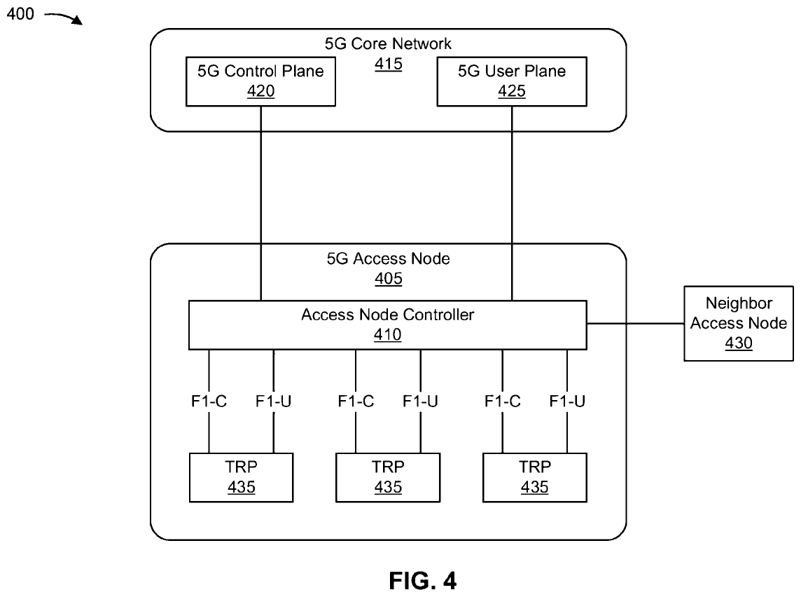

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

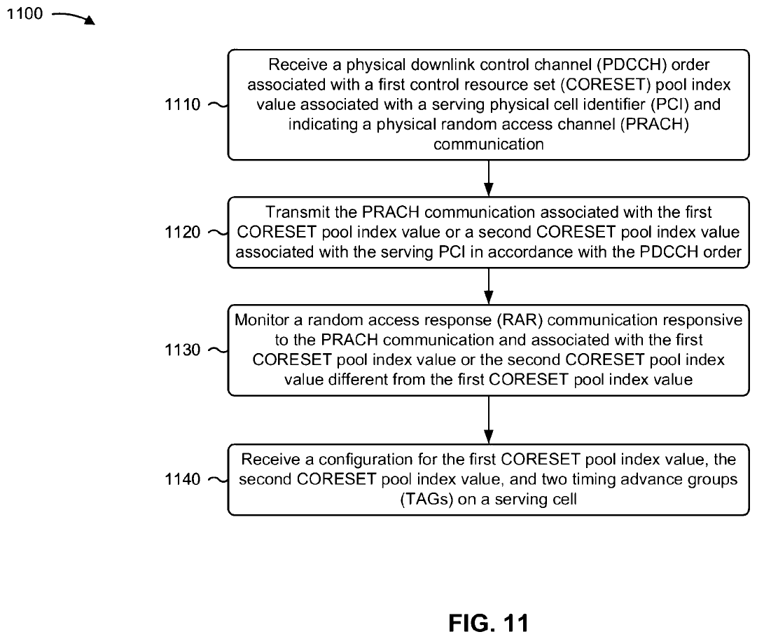

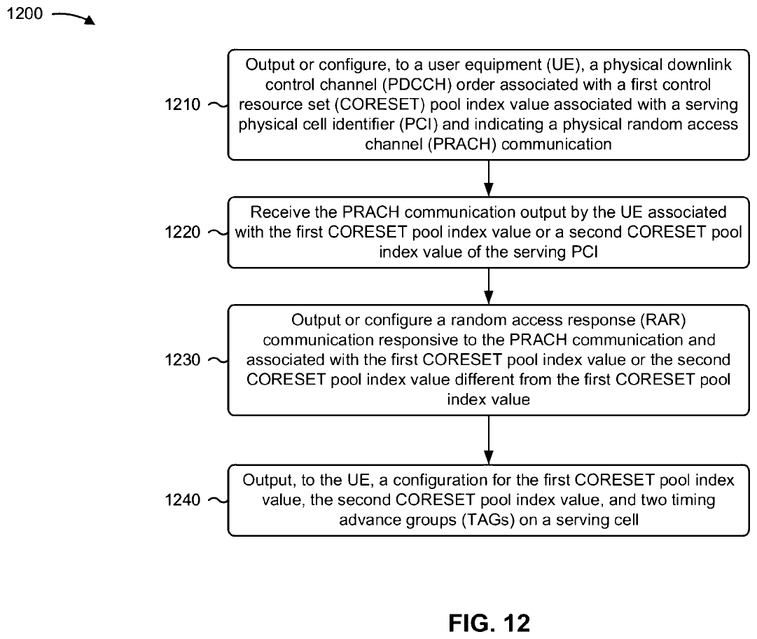

The controller/processor 240 of the network node 110, the controller/processor 280 of the UE 120, and/or any other component(s) of FIG. 2 may perform one or more techniques associated with CFRA for intra-cell mTRP, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving a configuration for a first CORESET pool index value, a second CORESET pool index value, and two timing advance groups on a serving cell; means for receiving a PDCCH order associated with the first CORESET pool index value associated with a serving PCI and indicating a PRACH communication; and/or means for transmitting the PRACH communication associated with the first CORESET pool index value or the second CORESET pool index value associated with the serving PCI in accordance with the PDCCH order. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting, to a UE 120, a configuration for a first CORESET pool index value, a second CORESET pool index value, and two timing advance groups on a serving cell; means for outputting, to the UE 120, a PDCCH order associated with the first CORESET pool index value associated with a serving PCI and indicating a PRACH communication; and/or means for receiving the PRACH communication output by the UE 120 associated with the first CORESET pool index value or the second CORESET pool index value of the serving PCI. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

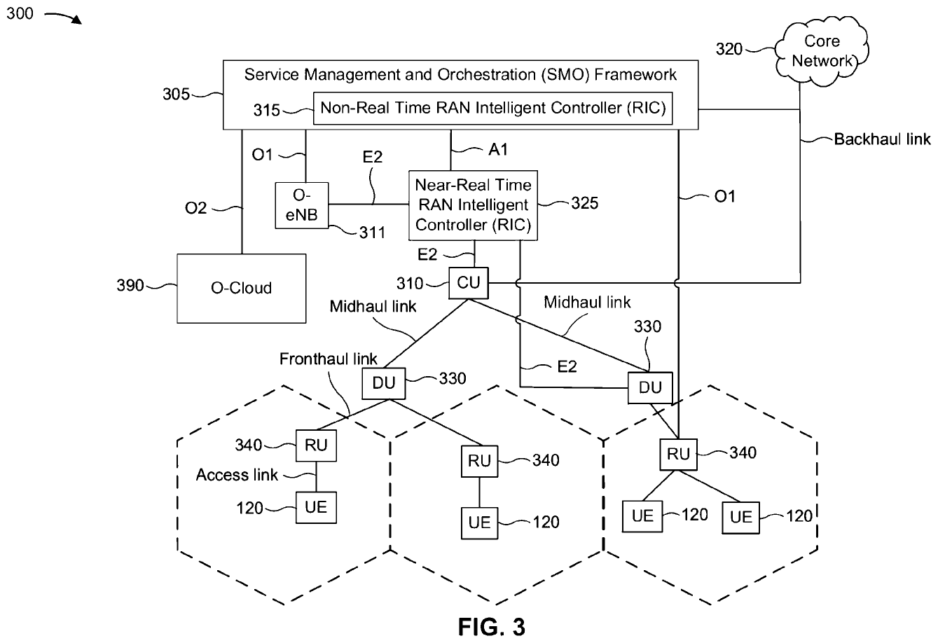

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

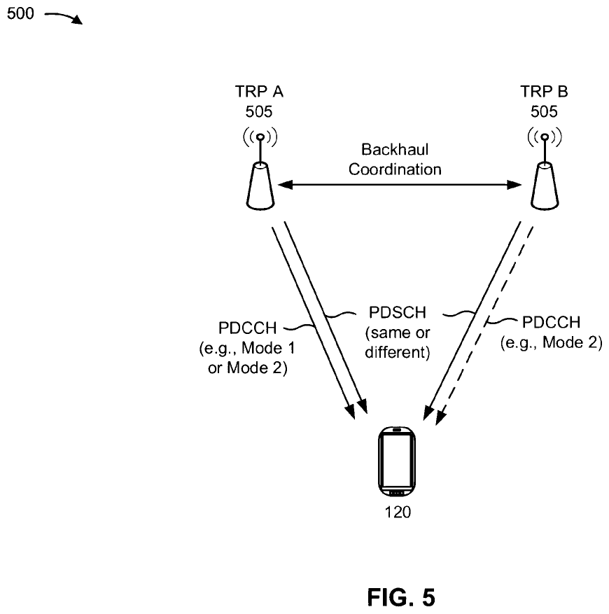

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers).

In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

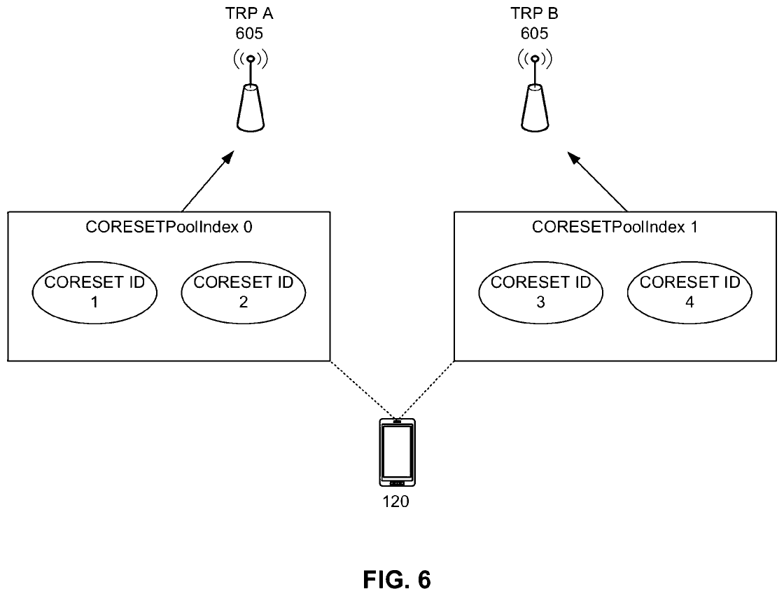

FIG. 6 is a diagram illustrating an example of TRP differentiation at a UE based at least in part on a CORESET pool index, in accordance with the present disclosure. In some aspects, a CORESET pool index (or CORESETPoolIndex) value may be used by a UE (such as a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) (or a first network node 110) may be associated with CORESET pool index 0 and a second TRP 605 (TRP B) (or a second network node 110) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 6 is provided as an example. Other examples may differ from what is described with respect to FIG. 6.

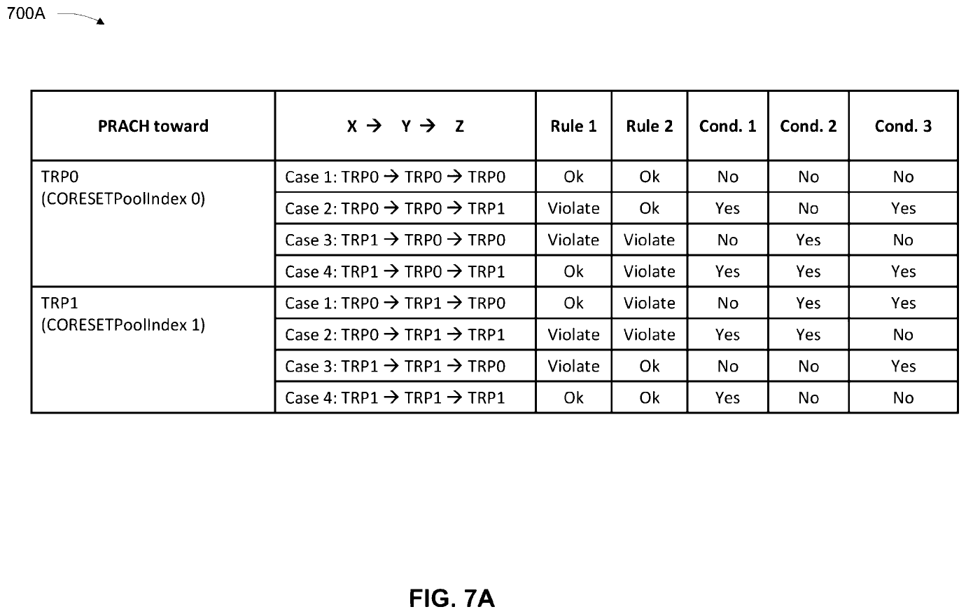

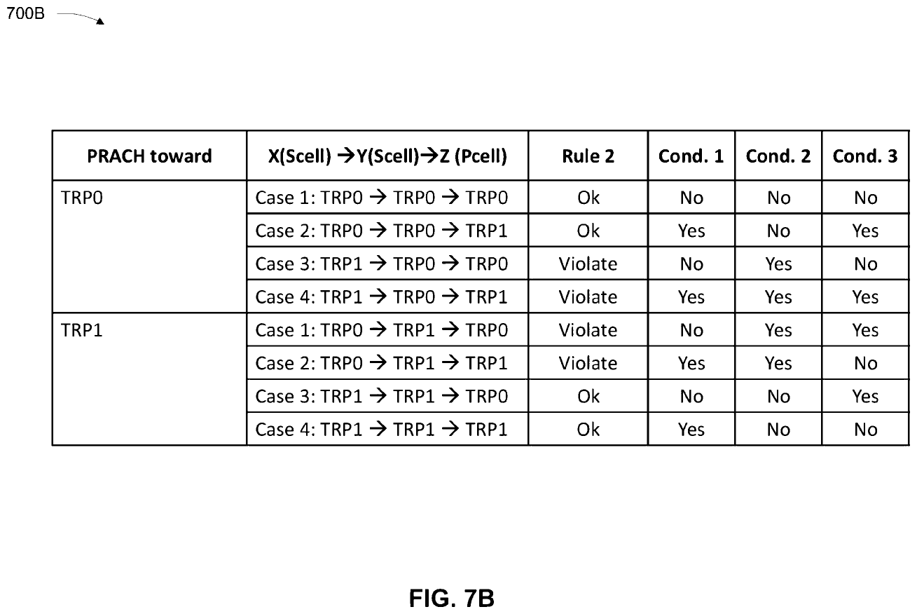

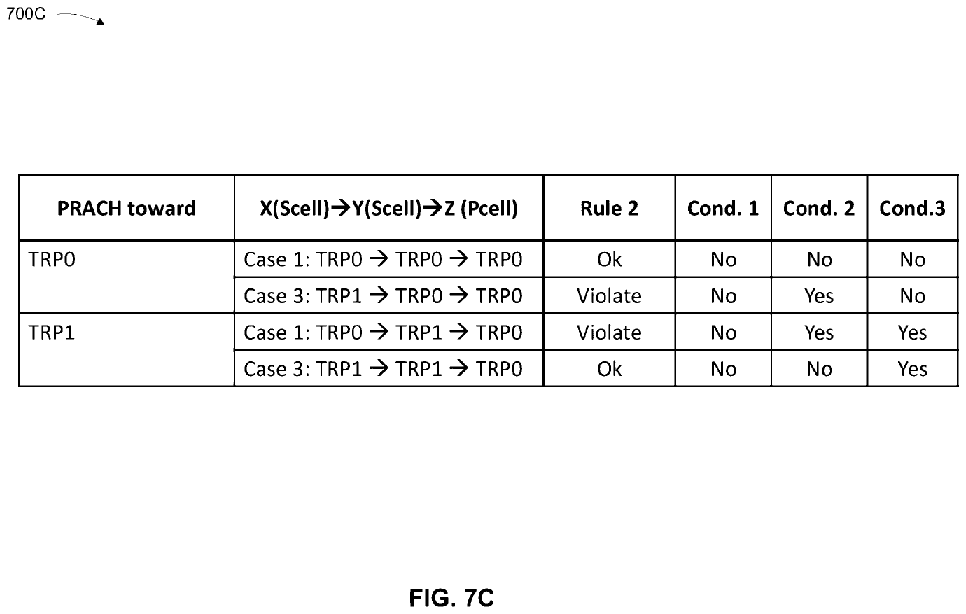

FIGS. 7A-7C are tables illustrating examples 700A-700C of intra-cell mTRP, in accordance with the present disclosure. The table in example 700A summarizes different possibilities for intra-cell mTRP on an SpCell for CFRA triggered by a PDCCH order (denoted by X->Y->Z) where X is the PDCCH order, Y is the PRACH, and Z is the RAR (PDCCH in Type-1 CSS and RAR PDSCH). The column “Rule 1” may refer to whether the UE 120 can assume that the DMRS ports of the RAR PDCCH/PDSCH and the DMRS ports of the PDCCH order are QCLed. The column “Rule 2” may refer to whether the UE 120 can assume the PL-RS and reference signal power are based on a DL-RS QCLed with the DMRS of the PDCCH order. The column “Condition 1” or (“Cond. 1”) may refer to whether a TCI state for a Type-1 CSS needs to be changed. The column “Condition 2” or (“Cond. 2”) may refer to whether an NIB would delay the PRACH triggering (which may require a cross-TRP PDCCH order). The column “Condition 3” or (“Cond. 3”) may refer to whether the NIB would delay the RAR (i.e., the RAR from a different TRP than the TRP that receives the PRACH communication).

In examples 700A-700C, the PDCCH order can be transmitted from a first TRP (TRP0) or a second TRP (TRP1). The PRACH communication may be transmitted toward the first TRP or the second TRP, and the RAR may be transmitted by the first TRP or the second TRP.

With reference to example 700A in FIG. 7A, when the PRACH is toward the first TRP, Rule 1 and Rule 2 are satisfied, as well as Conditions 1, 2, and 3, when the PDCCH order and the RAR are both transmitted from the first TRP (see Case 1 for the PRACH toward TRPO). When the PRACH is toward the second TRP, Rule 1 and 2 are satisfied when the PDCCH order and RAR are transmitted by the second TRP (see Case 4 for the PRACH toward TRP1). In Case 4 for the PRACH toward TRP1, however, Condition 1 is not satisfied, which means for implementations involving Case 4 for the PRACH toward TRP1, the TCI state for the Type-1 CSS will need to be changed. Case 3 for the PRACH toward TRP1 may also be acceptable if, for example, Rule 1 can be violated and the NIB delay of the RAR (Condition 3) can be addressed, as discussed in greater detail below. In some instances, Cases 1 or 2 for the PRACH toward TRP1 may also be acceptable if, for example, a cross-PDCCH order can be provided and Rules 1 and/or 2 can be violated or modified.

With reference to example 700B in FIG. 7B, for PRACH on an SCell, a primary cell (Pcell) may be configured with the same TRPs with multi-DCI based mTRP (which means Rule 1 is inapplicable). For a PRACH communication toward the first TRP (TRP0), Case 1 is the only case where Rule 2 and Conditions 1, 2, and 3 are satisfied. For a PRACH communication toward the second TRP (TRP1), Case 3 may be acceptable if the NIB delay of the RAR (Condition 3) can be addressed, as discussed in greater detail below. Case 4 for the PRACH toward TRP1 may be acceptable if the TCI state for the Type-1 CSS can be changed. Cases 1 and 2 for the PRACH toward TRP1 may be acceptable if a cross-TRP PDCCH order can be provided and Rule 2 can be violated or modified.

Like example 700B, the table of example 700C in FIG. 7C may also apply to PRACH on an Scell. The table of example 700C, however, represents an example where the Pcell is not configured for multi-DCI based mTRP. In that case, the Pcell may be configured with CORESET pool index 0 or may not be configured with a CORESET pool index at all. Accordingly, Rule 1 is not relevant (as in the table of example 700B), and Cases 2 and 4 are inapplicable for PRACH toward the first TRP and the second TRP. For a PRACH communication toward the first TRP (TRP0), Case 1 is the only case where Rule 2 and Conditions 1, 2, and 3 are satisfied. For a PRACH communication toward the second TRP (TRP1), Case 3 for the PRACH toward TRP1may be acceptable if the NIB delay of the RAR (Condition 3) can be addressed, as discussed in greater detail below. Case 1 for the PRACH toward TRP1 may be acceptable if a cross-TRP PDCCH order can be provided and Rule 2 can be violated or modified.

As indicated above, FIGS. 7A-7C are provided as examples. Other examples may differ from what is described with respect to FIGS. 7A-7C.

A UE 120 may attempt a CFRA procedure with a network node 110, such as a gNB, for various purposes such as TA acquisition, synchronizing network communications, beam failure recovery, handling system information requests, handovers to new network nodes, etc. In a CFRA procedure, the UE 120 is assigned a preamble, which is included with random access communications to the network node.

As indicated in the tables shown in examples 700A-700C, configuring a UE 120 with multiple CORESET pool index values and multiple TAGs may allow the UE 120 to participate in inter-cell or intra-cell mTRP communications. However, inter-cell and intra-cell mTRP communications can present challenges, as noted above. For example, for CFRA on an SpCell, the UE 120 may assume that the DMRS ports of the RAR PDCCH/PDSCH and the DMRS ports of the PDCCH order are QCLed. That is not the case for CFRA on an Scell. For PRACH power control, the UE 120 may assume that the PL-RS and reference signal power are based on a DL-RS that the DMRS of the PDCCH order is QCLed with. Such a QCL relationship may not be valid in certain intra-cell mTRP implementations, however. In another example, the UE 120 cannot receive the Type-I CSS from the network node 110 with an additional active PCI.

Accordingly, without additional configurations or information, the UE 120 may not be able to engage in a CFRA procedure in an intra-cell mTRP scenario involving an SCell, an SpCell, or both, because certain assumptions or configurations of the UE 120 may be inapplicable to certain intra-cell mTRP communications. For example, in the case of a PRACH communication on an SpCell, the UE 120 may not be able to comply with Rule 1, discussed above in connection with FIGS. 7A-7C. In the case of a PRACH communication on an SpCell or Scell, the UE 120 may not be able to comply with Rule 2. With respect to RAR reception, because Type-I CSS is associated with a common CORESET configured with a CORESET pool index value (or not configured with any CORESET pool index values so a default value of “0” is applied), the Type-1 CSS can only be received from a fixed TRP. For a PRACH communication toward a different TRP than the Type-1 CSS, some additional delay for the RAR communication may be introduced due to the NIB between the TRP receiving the PRACH communication and the TRP transmitting the RAR. Additionally, to avoid the NIB delay for RAR reception, the UE 120 may expect to receive the RAR from either the first TRP or the second TRP depending on which TRP the PRACH communication was transmitted toward. As such, some enhancements to the Type-1 CSS may be advantageous to support these use cases.

Some techniques and apparatuses described herein enable the UE 120 to receive a PDCCH order associated with a first CORESET pool index value associated with a serving PCI and indicating a PRACH communication; transmit the PRACH communication associated with the first CORESET pool index value or a second CORESET pool index value associated with the serving PCI in accordance with the PDCCH order; and monitor a RAR communication responsive to the PRACH communication and associated with the first CORESET pool index value or the second CORESET pool index value different from the first CORESET pool index value. As a result, the UE 120 can be configured to engage in CFRA for intra-cell mTRP. For example, the UE 120 can be configured to receive the RAR communication from a TRP with a different CORESET pool index than the CORESET pool index of the TRP that received the PRACH communication.

Some techniques and apparatuses described herein enable the network node 110 to output or configure, to a UE, a PDCCH order associated with a first CORESET pool index value associated with a serving PCI and indicating a PRACH communication; receive the PRACH communication output by the UE associated with the first CORESET pool index value or a second CORESET pool index value of the serving PCI; and output or configure a RAR communication responsive to the PRACH communication and associated with the first CORESET pool index value or the second CORESET pool index value different from the first CORESET pool index value. As a result, the network node 110 can configure the UE 120 to communicate with multiple TRPs during the CFRA procedure while minimizing the impact of various conditions, including NIB delay.

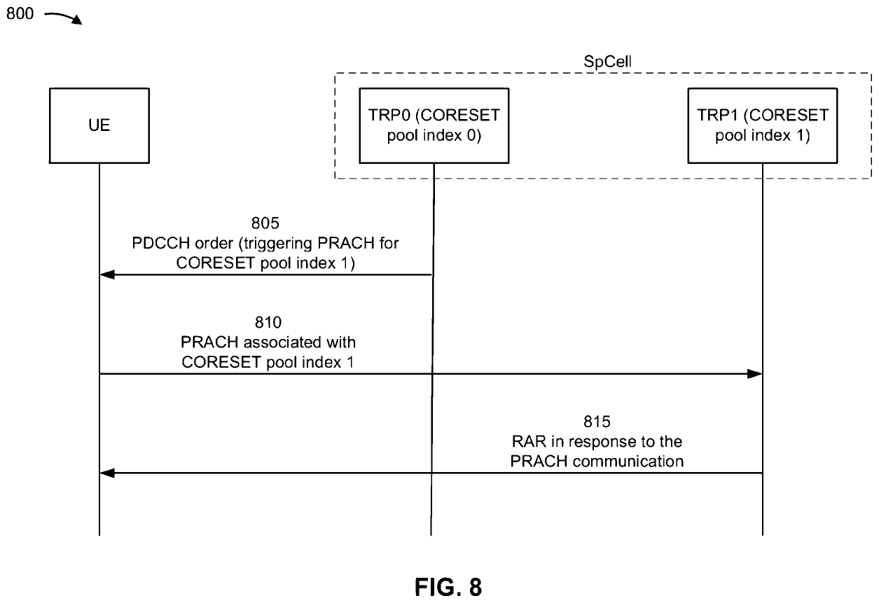

FIG. 8 is a diagram illustrating an example 800 associated with CFRA for intra-cell mTRP, in accordance with the present disclosure. As shown in FIG. 8, TRPs of an SpCell of a network node (such as network node 110) and a UE (such as UE 120) may communicate with one another. The TRPs may include a first TRP (TRP0) and a second TRP (TRP1). In some aspects, the UE is configured with at least two CORESET pool index values (including a first CORESET pool index value and a second POOL index value) and two TAGs on a serving cell.

As shown by reference number 805, the first TRP may transmit, and the UE may receive, a PDCCH order. The PDCCH order may trigger a PRACH communication for the second CORESET pool index value (e.g., CORESET pool index 1). The first CORESET pool index value may be associated with a servicing cell PCI, and the PDCCH order may indicate the PRACH communication. In some aspects, the PDCCH order may be associated with the first CORESET pool index value. In some aspects, the PDCCH order may indicate a specific CORESET pool index value. The specific CORESET pool index value may be predefined or configured via RRC signaling. In some instances, the specific CORESET pool index value is the first CORESET pool index value or the second CORESET pool index value (e.g., CORESET pool index 1).

As shown by reference number 810, the UE may transmit, and the second TRP may receive, the PRACH communication associated with the second CORESET pool index value, associated with the serving PCI in accordance with the PDCCH order. In aspects where the PDCCH order is associated with a first CORESET pool index value and indicates a PRACH associated with a specific CORESET pool index value, the UE may monitor the RAR communication associated with a second CORESET pool index value. In some aspects, the PDCCH order is associated with the first CORESET pool index value, and transmitting the PRACH communication associated with the second CORESET pool index value in accordance with the PDCCH order occurs as a result of the second CORESET pool index value being a fixed value or a value configured by RRC signaling. In some aspects, the PRACH communication is transmitted on an SpCell or an SCell.

As shown by reference number 815, the second TRP may transmit, and the UE may receive, the RAR communication responsive to the PRACH communication associated with the second CORESET pool index value. In some aspects, the UE may monitor for the RAR associated with the second CORESET pool index value based on the PRACH communication being associated with the second CORESET pool index value even though the PDCCH order is associated with the first CORESET pool index value.

As indicated above, FIG. 8 is provided as an example. Other examples may differ from what is described with respect to FIG. 8.

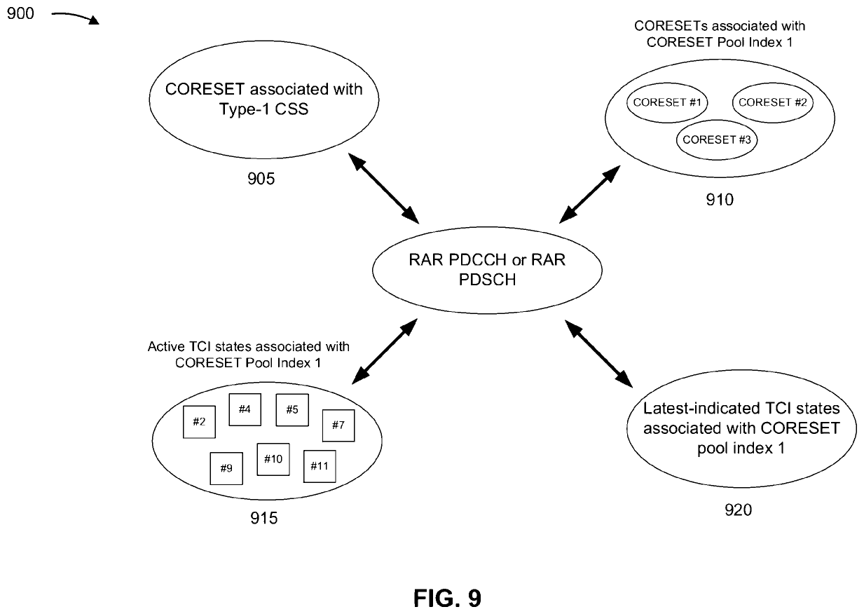

FIG. 9 is a diagram illustrating an example 900 associated with determining a DMRS antenna port QCL property for the RAR, in accordance with the present disclosure. In some aspects, the UE may determine the DMRS antenna port QCL property for the RAR communication and apply the DMRS antenna port QCL property based, at least in part, on the PDCCH order being associated with the first CORESET pool index value and the RAR being associated with the second CORESET pool index value.

As shown by reference number 905, in some aspects, the DMRS antenna port QCL property may be determined, at least in part, from a DL-RS of a TCI state of a CORESET associated with a Type-1 PDCCH CSS set. As shown by reference number 910, in some aspects, the DMRS antenna port QCL property may be determined, at least in part, from a DL-RS of an active TCI state of a CORESET with a lowest CORESET identifier (e.g., CORESET #1 in FIG. 9) associated with the same CORESET pool index value (e.g., CORESET pool index 1) as a CORESET of a Type-1 CSS set. As shown by reference number 915, the DMRS antenna port QCL property may be determined, at least in part, from a DL-RS of an active TCI state with a lowest identifier (e.g., TCI state #2 in FIG. 9) associated with the same CORESET pool index value (e.g., CORESET pool index 1) as a CORESET of a Type-1 CSS set. As shown by element 920, in some aspects, the DMRS antenna port QCL property may be determined, at least in part, from a DL-RS of a latest-indicated TCI state associated with the same CORESET pool index value (e.g., CORESET pool index 1) as the CORESET of the Type-1 CSS set.

In some aspects, the UE may further or alternatively determine the PL-RS and a reference signal power for the PRACH transmit power. In some aspects, the UE may apply the PL-RS and reference signal power based, at least in part, on the PDCCH order being associated with the first CORESET pool index value and the PRACH communication being associated with the second CORESET pool index value. In some aspects, the PL-RS and the reference signal power for the PRACH transmit power may be determined, at least in part, from a DL-RS of an active TCI state with a lowest identifier among one or more TCI states associated with the same CORESET pool index value as the PRACH. In some aspects, the PL-RS and the reference signal power for the PRACH transmit power may be determined, at least in part, from a DL-RS of an active TCI state of a CORESET having a lowest identifier among one or more CORESETs associated with the same CORESET pool index value as the PRACH. In some aspects, the PL-RS and the reference signal power for the PRACH transmit power may be determined, at least in part, from a DL-RS of a latest-indicated TCI state associated with the same CORESET pool index value as the PRACH in a unified TCI state. In some aspects, the PL-RS and the reference signal power for the PRACH transmit power may be determined, at least in part, from a PL-RS of a physical uplink control channel (PUCCH) resource with a lowest identifier associated with the same CORESET pool index as the PRACH. In some aspects, the PUCCH resource is one of a plurality of PUCCH resources, each associated with one of the first CORESET pool index or the second CORESET pool index. In some aspects, the PL-RS and the reference signal power for the PRACH transmit power may be determined, at least in part, from a synchronization signal block (SSB) associated with the PRACH communication and indicated by an SSB index field in the PDCCH order. In some aspects, the PL-RS and the reference signal power for the PRACH transmit power may be determined, at least in part, from a DL-RS that is QCLed with the SSB associated with the PRACH communication and indicated by an SSB index field in the PDCCH order.

As indicated above, FIG. 9 is provided as an example. Other examples may differ from what is described with respect to FIG. 9.

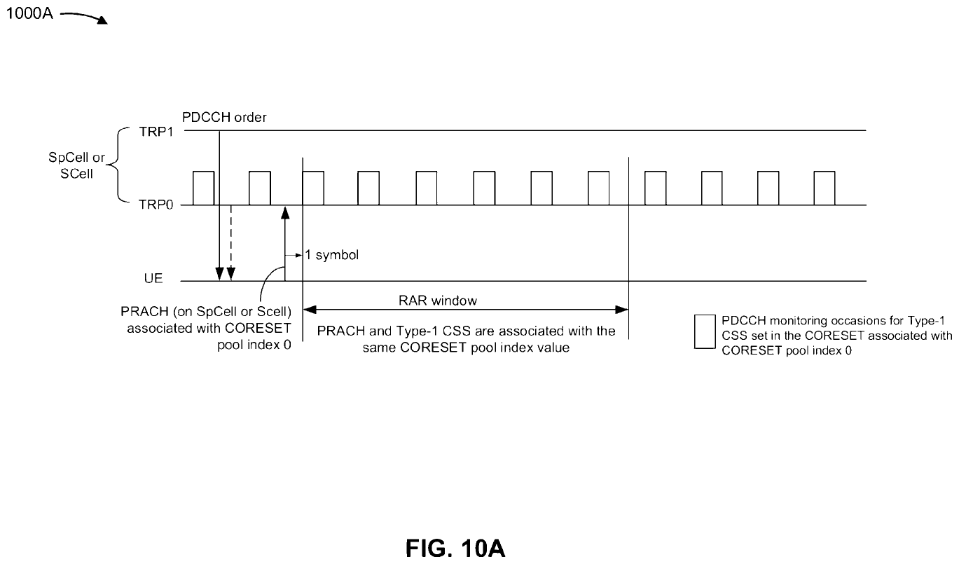

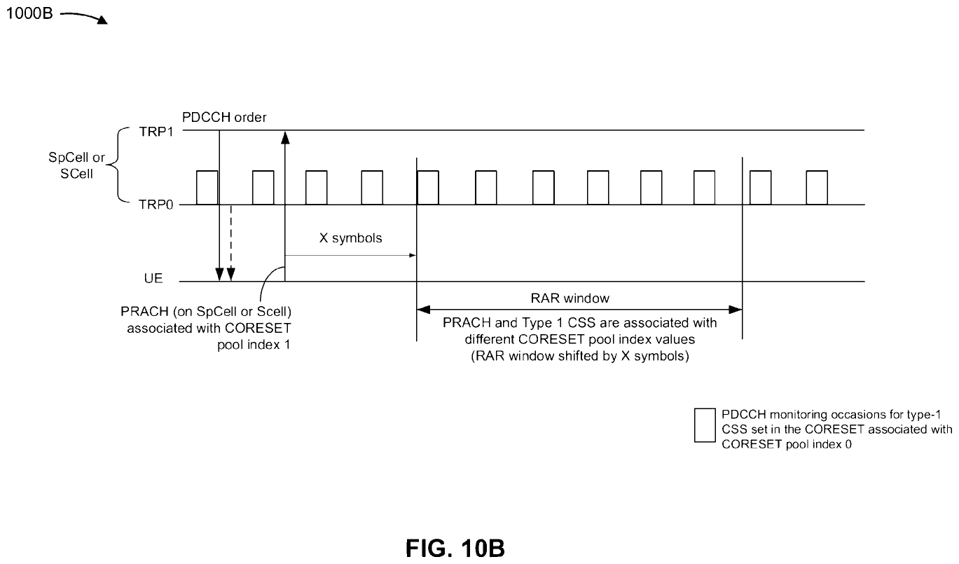

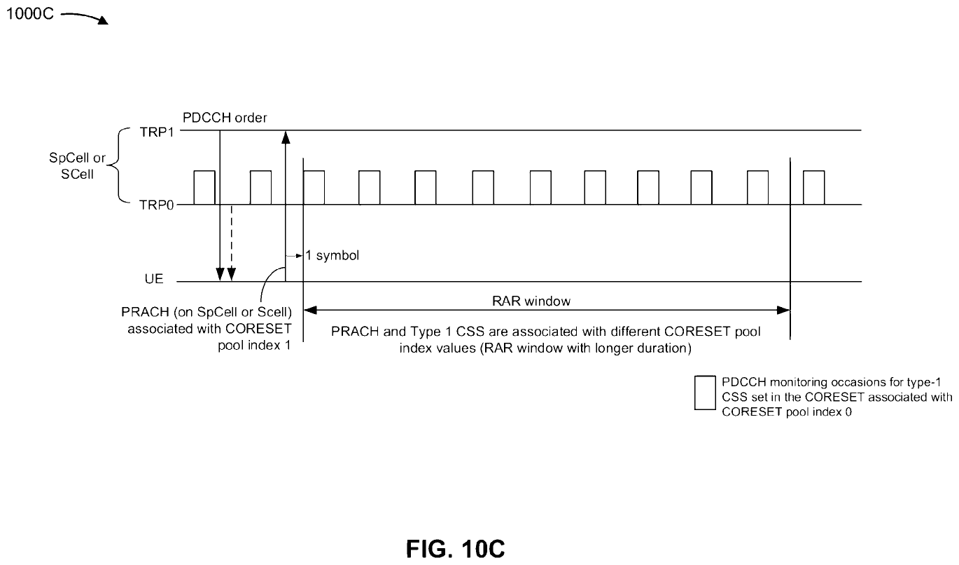

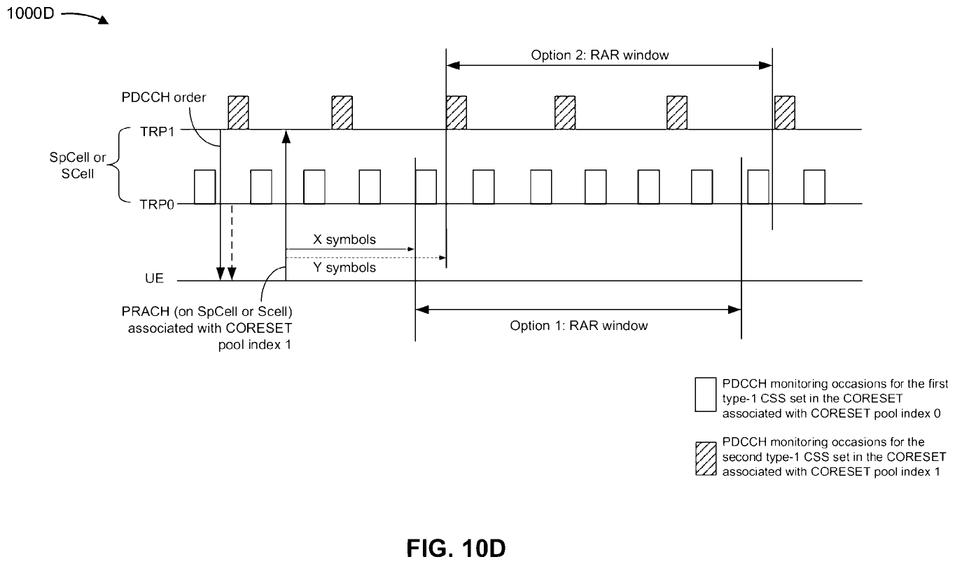

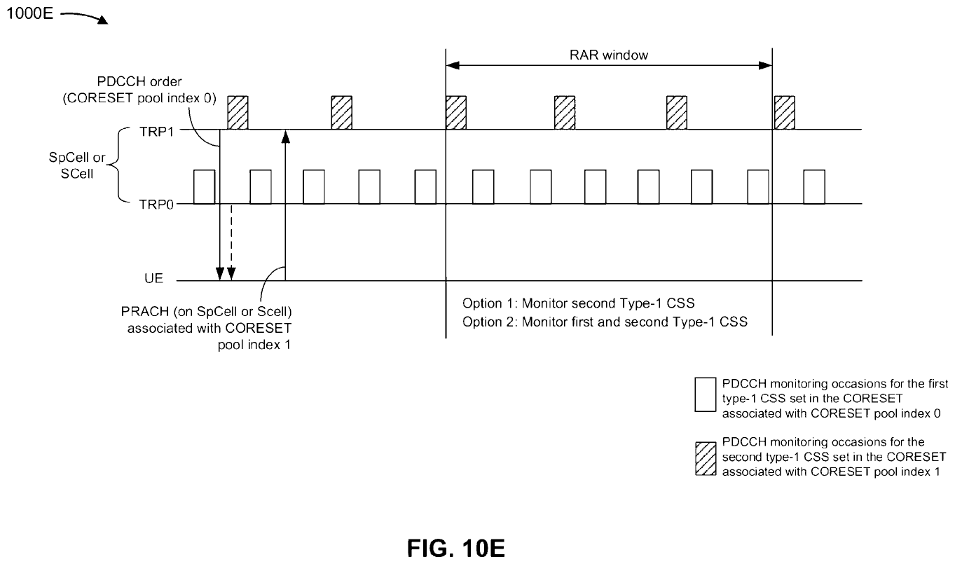

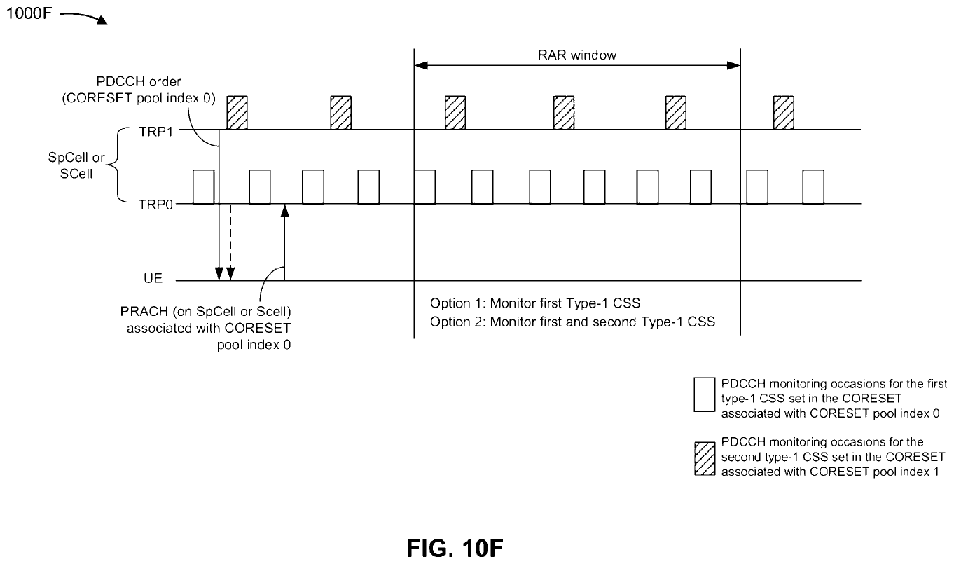

FIGS. 10A-10F are diagrams illustrating examples 1000A-1000F associated with RAR windows, in accordance with the present disclosure. As illustrated in examples 1000A-1000F, a UE (such as UE 120) may communicate with an SpCell or an SCell of a network node (such as network node 110). The communication between the UE and the network node may include communication between the UE and a first TRP (TRP0) and a second TRP (TRP1). In the examples 1000A-1000F, the PDCCH order may be transmitted from the first TRP or the second TRP. The PRACH communication may be associated with the first CORESET pool index value (e.g., CORESET pool index value 0) as shown in examples 1000A and 1000F. Alternatively, the PRACH communication may be associated with the second CORESET pool index value (e.g., CORESET pool index value 1) as shown in examples 1000B-1000E.

With reference to FIG. 10A, example 1000A illustrates an example where the PRACH and the Type-1 CSS are associated with the same CORESET pool index value. As shown, an RAR window, which is a window of time in which the UE monitors for the RAR from the SpCell, has an RAR window start time beginning at the first symbol of the earliest CORESET associated with Type-1 CSS set which is at least one symbol after the transmission of the PRACH communication and a predefined or configured RAR window duration. In the example 1000A, the UE monitors the PDCCH for Type-1 CSS set in the CORESET associated with the first CORESET pool index value.

With reference to FIG. 10B, example 1000B illustrates an example where the PRACH and the Type-1 CSS are associated with different CORESET pool index values. As shown, the RAR window has an RAR window start time beginning at the first symbol of the earliest CORESET associated with Type-1 CSS set which is at least X number of symbols after the transmission of the PRACH communication. Accordingly, the RAR window start time is shifted by X symbols. The value for X and the length of the RAR window duration may be predefined and/or configured, among other examples. In some aspects, the value of X may account for NIB delay, which may occur in instances where the PRACH and the Type-1 CSS are associated with different CORESET pool index values, as discussed above. In the example 1000B, the UE monitors the PDCCH for Type-1 CSS sets in the CORESET associated with the first CORESET pool index value.

With reference to FIG. 10C, example 1000C illustrates an example where the PRACH and the Type-1 CSS are associated with different CORESET pool index values. As shown, the RAR window has an RAR window start time beginning at the first symbol of the earliest CORESET associated with Type-1 CSS set which is at least one symbol after the transmission of the PRACH communication. The RAR window duration is extended, however, as compared to the RAR window in example 1000A where the PRACH and the Type-1 CSS are associated with the same CORESET pool index value. The length of the RAR window duration may be predefined and/or configured, among other examples. In some aspects, the length of the extension of the RAR window duration may account for NIB delay, which may occur in instances where the PRACH and the Type-1 CSS are associated with different CORESET pool index values, as discussed above. In some aspects, the RAR window of example 1000C may include an original RAR window and an extended RAR window added to the original RAR window. Alternatively, in some aspects, a single extended RAR window may be configured or defined. In the example 1000C, the UE monitors the PDCCH for Type-1 CSS sets in the CORESET associated with the first CORESET pool index value.

With reference to FIG. 10D, example 1000D illustrates an example where the UE may be configured two Type-1 CSS sets on an SpCell, where a first Type-1 CSS set is associated with a first CORESET corresponding to a first CORESET pool index value and a second Type-1 CSS set is associated with a second CORESET corresponding to a second CORESET pool index value. In some aspects, the UE may determine an RAR window beginning at the first symbol of the earliest CORESET of the first CORESET and the second CORESET which is at least X number of symbols after the transmission of the PRACH as shown in option 1 of FIG. 10D. In some aspects, the UE may determine the RAR window associated with each CORESET pool index value, respectively. For example, the UE may determine a first RAR window beginning at the first symbol of the earliest CORESET associated with the first Type-1 CSS set which is at least Y number of symbols after the transmission of the PRACH associated with the first CORESET pool index value. The UE may determine a second RAR window beginning at the first symbol of the earliest CORESET associated with the second Type-1 CSS set which is at least Y number of symbols after the transmission of PRACH associated with the second CORESET pool index value as shown in option 2 of FIG. 10D. Alternatively or additionally, the UE may use a common RAR window duration for both the first CORESET pool index value and the second CORESET pool index value or the UE may use a separate RAR window duration for each CORESET pool index value. In some aspects, the values for X and Y may be the same or different. In some aspects, the values for X, Y, or both, may be predefined or configured to, for example, reduce NIB delay, as discussed above.

With reference to FIG. 10E, example 1000E illustrates an example where the UE may be configured with two Type-1 CSS sets on an SpCell, where a first Type-1 CSS set is associated with a first CORESET corresponding to a first CORESET pool index value and a second Type-1 CSS set is associated with a second CORESET corresponding to a second CORESET pool index value. In some aspects, the UE may monitor both the first Type-1 CSS and the second Type-1 CSS within the RAR window associated with a PRACH transmission as shown in option 2 of FIG. 10E. Alternatively, the UE may monitor both the first Type-1 CSS set and the second Type-1 CSS set within the RAR window only when the PRACH is associated with a specific CORESET pool index value (e.g., CORESET pool index 1). As shown in FIG. 10E, the UE monitor both the first Type-1 CSS set and the second Type-1 CSS set within the RAR window since the PRACH is associated with CORESET pool index 1. Alternatively, for a PRACH transmission associated with a given CORESET pool index value, the UE may only monitor the Type-1 CSS set in the CORESET associated with the given CORESET pool index value within the RAR window as shown in option 1 of FIG. 10E. In the example, the UE may only monitor the second Type-1 CSS set within the RAR window since the PRACH is associated with the second CORESET pool index value, e.g. CORESET pool index 1.

With reference to FIG. 10F, example 1000F illustrates an example where the UE may be configured with two Type-1 CSS sets on an SpCell, where a first Type-1 CSS set is associated with a first CORESET corresponding to a first CORESET pool index value and a second Type-1 CSS set is associated with a second CORESET corresponding to a second CORESET pool index value. In some aspects, the UE may monitor both the first Type-1 CSS and the second Type-1 CSS within the RAR window associated with a PRACH transmission as shown in option 2 of FIG. 10F. Alternatively, the UE may monitor both the first Type-1 CSS set and the second Type-1 CSS set within the RAR window only when the PRACH is associated with a specific CORESET pool index value (e.g., CORESET pool index 1). As shown in FIG. 10F, the UE may only monitor the first Type-1 CSS set within the RAR window since the PRACH is associated with CORESET pool index 0. Alternatively, for a PRACH transmission associated with a given CORESET pool index value, the UE may only monitor the Type-1 CSS set in the CORESET associated with the given CORESET pool index value within the RAR window as shown in option 1 of FIG. 10F. In the example, the UE may only monitor the first Type-1 CSS set within the RAR window since the PRACH is associated with the first CORESET pool index value, e.g. CORESET pool index 0.

As shown by the examples 1000A-1000F, in some aspects, the UE may transmit a PRACH associated with a first CORESET pool index value and receive a Type-1 CSS configuration associated with a third CORESET pool index value (which may be equal to the first CORESET pool index value, the second CORESET pool index value, and/or a combination thereof, among other examples) on the serving cell. The term “third CORESET pool index value” may refer to one of the first CORESET pool index value or the second CORESET pool index value. In some aspects, the UE may determine an RAR window based, at least in part, on the first CORESET pool index value and the third CORESET pool index value. In some aspects, the RAR window may be defined by an RAR window duration and an RAR window start time. The RAR window start time may be based, at least in part, on the first CORESET pool index value and the third CORESET pool index value. In some aspects, the RAR window start time may begin at a first symbol of an earliest CORESET associated with a Type-1 CSS, and the first symbol may be at least one symbol after a last symbol of a PRACH occasion corresponding to the PRACH communication based, at least in part, on the first CORESET pool index value and the third CORESET pool index value being the same value. In some aspects, the RAR window start time may begin at a first symbol of an earliest CORESET associated with a Type-1 CSS, and the first symbol may be a predetermined number of symbols or slots, or a predetermined amount of time, after a last symbol of a PRACH occasion corresponding to the PRACH communication based, at least in part, on the first CORESET pool index value and the third CORESET pool index value are different from one another. In some aspects, the RAR window duration is based, at least in part, on the first CORESET pool index value and the third CORESET pool index value. In some aspects, the RAR window duration may correspond to a first window duration configured using an existing RRC parameter based, at least in part, on the first CORESET pool index value and the third CORESET pool index value are the same. In some aspects, the RAR window duration may be based, at least in part, on a second window duration configured using a new RRC parameter based, at least in part, on the first CORESET pool index value and the third CORESET pool index value being different from one another. In some aspects, the RAR window duration may be based, at least in part, on a first window duration plus an extended window duration wherein the extended window duration is predefined or configured using a new RRC parameter.

In some aspects, the UE may receive a configuration for the first CORESET pool index value and the second CORESET pool index value on an SpCell, receive a configuration for a first Type-1 CSS set associated with a first CORESET corresponding to the first CORESET pool index value, and receive a configuration for a second Type-1 CSS set associated with a second CORESET corresponding to the second CORESET pool index value. In some aspects, the UE may determine the RAR window for the PRACH communication associated with one or more of the first CORESET pool index value or the second CORESET pool index value. In some aspects, a separate RAR window duration may be configured for each of the first CORESET pool index value and the second CORESET pool index value. In some aspects, a single RAR window duration may be configured for both the first CORESET pool index value and the second CORESET pool index value. In some aspects, the UE may determine the RAR window start time to be a first symbol of an earliest CORESET of the first CORESET and the second CORESET, where the first symbol is at least a predetermined number of symbols after a last symbol of a PRACH occasion corresponding to the PRACH communication. In some aspects, the RAR window start time may be a first symbol of an earliest CORESET associated with the first Type-1 CSS set, where the first symbol is at least a predetermined number of symbols after a last symbol of a PRACH occasion corresponding to the PRACH communication based, at least in part, on the PRACH communication being associated with the first CORESET pool index. In some aspects, the RAR window start time may be a first symbol of an earliest CORESET associated with the second Type-1 CSS set, where the first symbol is at least a predetermined number of symbols after a last symbol of a PRACH occasion corresponding to the PRACH communication based, at least in part, on the PRACH communication being associated with the second CORESET pool index.

In some aspects, the UE may monitor both the first Type-1 CSS in the first CORESET and the second Type-1 CSS in the second CORESET within the RAR window associated with the PRACH communication. In some aspects, monitoring both the first Type-1 CSS in the first CORESET and the second Type-1 CSS in the second CORESET is based, at least in part, on the PRACH transmission being associated with a specific CORESET pool index value. In some aspects, monitoring the first Type-1 CSS in the first CORESET is a result of the PRACH being associated with the first CORESET pool index value. In some aspects, monitoring the second Type-1 CSS in the second CORESET is a result of the PRACH being associated with the second CORESET pool index value.

As indicated above, FIGS. 10A-10F are provided as an example. Other examples may differ from what is described with respect to FIGS. 10A-10F.

FIG. 11 is a diagram illustrating an example process 1100 performed, for example, by a UE, in accordance with the present disclosure. Example process 1100 is an example where the UE (e.g., UE 120) performs operations associated with CFRA for intra-cell mTRP communication.

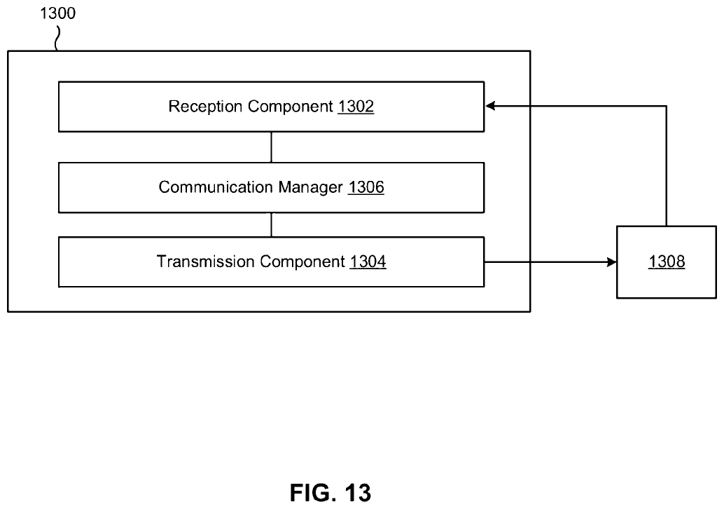

As shown in FIG. 11, in some aspects, process 1100 may include receiving a PDCCH order associated with a first CORESET pool index value associated with a serving PCI and indicating a PRACH communication (block 1110). For example, the UE (e.g., using reception component 1302 and/or communication manager 1306, depicted in FIG. 13) may receive a PDCCH order associated with a first CORESET pool index value associated with a serving PCI and indicating a PRACH communication, as described above.

As further shown in FIG. 11, in some aspects, process 1100 may include transmitting the PRACH communication associated with the first CORESET pool index value or a second CORESET pool index value associated with the serving PCI in accordance with the PDCCH order (block 1120). For example, the UE (e.g., using transmission component 1304 and/or communication manager 1306, depicted in FIG. 13) may transmit the PRACH communication associated with the first CORESET pool index value or a second CORESET pool index value associated with the serving PCI in accordance with the PDCCH order, as described above.

As further shown in FIG. 11, in some aspects, process 1100 may include monitoring a RAR communication responsive to the PRACH communication and associated with the first CORESET pool index value or the second CORESET pool index value different from the first CORESET pool index value (block 1130). For example, the UE (e.g., using communication manager 1306, depicted in FIG. 13) may monitor a RAR communication responsive to the PRACH communication and associated with the first CORESET pool index value or the second CORESET pool index value different from the first CORESET pool index value, as described above.

As further shown in FIG. 11, in some aspects, process 1100 may include receiving a configuration for the first CORESET pool index value, the second CORESET pool index value, and two TAGs on a serving cell (block 1140). For example, the UE (e.g., using reception component 1302 and/or communication manager 1306, depicted in FIG. 13) may receive a configuration for the first CORESET pool index value, the second CORESET pool index value, and two TAGs on a serving cell, as described above.

Process 1100 may include additional aspects, such as any single aspect or any combination of aspects described below and/or in connection with one or more other processes described elsewhere herein.

In a first aspect, process 1100 includes receiving a configuration for the first CORESET pool index value, the second CORESET pool index value, and two TAGs on a special cell.

In a second aspect, alone or in combination with the first aspect, the PDCCH order is associated with the first CORESET pool index value and indicates the PRACH communication associated with a specific CORESET pool index value, and monitoring the RAR communication associated with the second CORESET pool index value occurs as a result of the PRACH communication being associated with the specific CORESET pool index value.

In a third aspect, alone or in combination with one or more of the first and second aspects, the specific CORESET pool index value is configured by RRC signaling.

In a fourth aspect, alone or in combination with one or more of the first through third aspects, the specific CORESET pool index value is one of the first CORESET pool index value or the second CORESET pool index value.

In a fifth aspect, alone or in combination with one or more of the first through fourth aspects, process 1100 includes determining a DMRS antenna port QCL property for the RAR communication, and applying the DMRS based, at least in part, on the PDCCH order being associated with the first CORESET pool index value and the RAR being associated with the second CORESET pool index value.

In a sixth aspect, alone or in combination with one or more of the first through fifth aspects, the DMRS antenna port QCL property is determined, at least in part, from a DL-RS of a TCI state of a CORESET associated with a Type-1 PDCCH CSS set.

In a seventh aspect, alone or in combination with one or more of the first through sixth aspects, the DMRS antenna port QCL property is determined, at least in part, from a DL-RS of an active TCI state of a CORESET with a lowest CORESET identifier associated with a same CORESET pool index value as a CORESET of a Type-1 CSS set.

In an eighth aspect, alone or in combination with one or more of the first through seventh aspects, the DMRS antenna port QCL property is determined, at least in part, from a DL-RS of an active TCI state with a lowest identifier associated with a same CORESET pool index value as a CORESET of a Type-1 CSS set.

In a ninth aspect, alone or in combination with one or more of the first through eighth aspects, the DMRS antenna port QCL property is determined, at least in part, from a DL-RS of a latest-indicated TCI state associated with a same CORESET pool index value as a CORESET of a Type-1 CSS set.

In a tenth aspect, alone or in combination with one or more of the first through ninth aspects, as discussed above, process 1100 includes receiving a configuration for the first CORESET pool index value, the second CORESET pool index value, and two TAGs on a serving cell.

In an eleventh aspect, alone or in combination with one or more of the first through tenth aspects, the PDCCH order is associated with the first CORESET pool index value, and transmitting the PRACH communication associated with the second CORESET pool index value in accordance with the PDCCH order occurs as a result of the second CORESET pool index value being a fixed value or configured by radio resource control signaling.

In a twelfth aspect, alone or in combination with one or more of the first through eleventh aspects, process 1100 includes determining a PL-RS and a reference signal power for a PRACH transmit power, and applying the PL-RS and reference signal power based, at least in part, on the PDCCH order being associated with the first CORESET pool index value and the PRACH being associated with the second CORESET pool index value.

In a thirteenth aspect, alone or in combination with one or more of the first through twelfth aspects, the PL-RS and the reference signal power for the PRACH transmit power are determined, at least in part, from a DL-RS of an active TCI state with a lowest identifier among one or more TCI states associated with a same CORESET pool index value as the PRACH.

In a fourteenth aspect, alone or in combination with one or more of the first through thirteenth aspects, the PL-RS and the reference signal power for the PRACH transmit power are determined, at least in part, from a DL-RS of an active TCI state of a CORESET having a lowest identifier among one or more CORESETs associated with a same CORESET pool index value as the PRACH.

In a fifteenth aspect, alone or in combination with one or more of the first through fourteenth aspects, the PL-RS and the reference signal power for the PRACH transmit power are determined, at least in part, from a DL-RS of a latest-indicated TCI state associated with a same CORESET pool index value as the PRACH in a unified TCI state.

In a sixteenth aspect, alone or in combination with one or more of the first through fifteenth aspects, the PL-RS and the reference signal power for the PRACH transmit power are determined, at least in part, from a PL-RS of a PUCCH resource with a lowest identifier associated with a same CORESET pool index as the PRACH.

In a seventeenth aspect, alone or in combination with one or more of the first through sixteenth aspects, the PUCCH resource is one of a plurality of PUCCH resources, each associated with one of the first CORESET pool index or the second CORESET pool index.

In an eighteenth aspect, alone or in combination with one or more of the first through seventeenth aspects, the PL-RS and the reference signal power for the PRACH transmit power are determined, at least in part, from an SSB associated with the PRACH communication and indicated by an SSB field in the PDCCH order.

In a nineteenth aspect, alone or in combination with one or more of the first through eighteenth aspects, the PL-RS and the reference signal power for the PRACH transmit power are determined, at least in part, from a DL-RS that is QCLed with an SSB associated with the PRACH communication and indicated by an SSB index field in the PDCCH order.

In a twentieth aspect, alone or in combination with one or more of the first through nineteenth aspects, process 1100 includes receiving a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

In a twenty-first aspect, alone or in combination with one or more of the first through twentieth aspects, process 1100 includes determining an RAR window based, at least in part, on the first CORESET pool index value and the third CORESET pool index value.

In a twenty-second aspect, alone or in combination with one or more of the first through twenty-first aspects, the RAR window is defined by an RAR window duration and an RAR window start time, wherein the RAR window start time is based, at least in part, on the first CORESET pool index value and the third CORESET pool index value.

In a twenty-third aspect, alone or in combination with one or more of the first through twenty-second aspects, the RAR window start time begins at a first symbol of an earliest CORESET associated with a Type-1 CSS, wherein the first symbol is at least one symbol after a last symbol of a PRACH occasion corresponding to the PRACH communication based, at least in part, on the first CORESET pool index value and the third CORESET pool index value being a same value.

In a twenty-fourth aspect, alone or in combination with one or more of the first through twenty-third aspects, the RAR window start time begins at a first symbol of an earliest CORESET associated with a Type-1 CSS, wherein the first symbol is a predetermined number of symbols or slots, or a predetermined amount of time, after a last symbol of a PRACH occasion corresponding to the PRACH communication based, at least in part, on the first CORESET pool index value and the third CORESET pool index value being different from one another.

In a twenty-fifth aspect, alone or in combination with one or more of the first through twenty-fourth aspects, the RAR window duration is based, at least in part, on the first CORESET pool index value and the third CORESET pool index value.

In a twenty-sixth aspect, alone or in combination with one or more of the first through twenty-fifth aspects, the RAR window duration corresponds to a first window duration configured using an existing RRC parameter based, at least in part, on the first CORESET pool index value and the third CORESET pool index value being a same value.

In a twenty-seventh aspect, alone or in combination with one or more of the first through twenty-sixth aspects, the RAR window duration is based, at least in part, on a second window duration configured using a new RRC parameter based, at least in part, on the first CORESET pool index value and the third CORESET pool index value being different from one another.

In a twenty-eighth aspect, alone or in combination with one or more of the first through twenty-seventh aspects, the RAR window duration is based, at least in part, on a first window duration plus an extended window duration, wherein the extended window duration is predefined or configured using a new RRC parameter.

In a twenty-ninth aspect, alone or in combination with one or more of the first through twenty-eighth aspects, process 1100 includes receiving a configuration for the first CORESET pool index value and the second CORESET pool index value on a special cell, receiving a configuration for a first Type-1 CSS set associated with a first CORESET corresponding to the first CORESET pool index value, and receiving a configuration for a second Type-1 CSS set associated with a second CORESET corresponding to the second CORESET pool index value.

In a thirtieth aspect, alone or in combination with one or more of the first through twenty-ninth aspects, process 1100 includes determining an RAR window for the PRACH communication associated with one or more of the first CORESET pool index value or the second CORESET pool index value.

In a thirty-first aspect, alone or in combination with one or more of the first through thirtieth aspects, a different RAR window duration is configured for each of the first CORESET pool index value and the second CORESET pool index value.

In a thirty-second aspect, alone or in combination with one or more of the first through thirty-first aspects, a single RAR window duration is configured for both the first CORESET pool index value and the second CORESET pool index value.

In a thirty-third aspect, alone or in combination with one or more of the first through thirty-second aspects, determining the RAR window includes determining an RAR window start time, wherein the RAR window start time is a first symbol of an earliest CORESET of the first CORESET and the second CORESET, wherein the first symbol is at least a predetermined number of symbols after a last symbol of a PRACH occasion corresponding to the PRACH communication.

In a thirty-fourth aspect, alone or in combination with one or more of the first through thirty-third aspects, the RAR window start time is a first symbol of an earliest CORESET associated with the first Type-1 CSS set, wherein the first symbol is at least a predetermined number of symbols after a last symbol of a PRACH occasion corresponding to the PRACH communication based, at least in part, on the PRACH communication being associated with the first CORESET pool index.

In a thirty-fifth aspect, alone or in combination with one or more of the first through thirty-fourth aspects, the RAR window start time is a first symbol of an earliest CORESET associated with the second Type-1 CSS set, wherein the first symbol is at least a predetermined number of symbols after a last symbol of a PRACH occasion corresponding to the PRACH communication based, at least in part, on the PRACH communication being associated with the second CORESET pool index.

In a thirty-sixth aspect, alone or in combination with one or more of the first through thirty-fifth aspects, process 1100 includes monitoring both the first Type-1 CSS in the first CORESET and the second Type-1 CSS in the second CORESET within an RAR window associated with the PRACH communication.

In a thirty-seventh aspect, alone or in combination with one or more of the first through thirty-sixth aspects, monitoring both the first Type-1 CSS in the first CORESET and the second Type-1 CSS in the second CORESET is based, at least in part, on the PRACH transmission being associated with a specific CORESET pool index value.

In a thirty-eighth aspect, alone or in combination with one or more of the first through thirty-seventh aspects, process 1100 includes monitoring the first Type-1 CSS in the first CORESET as a result of the PRACH being associated with the first CORESET pool index value.

In a thirty-ninth aspect, alone or in combination with one or more of the first through thirty-eighth aspects, process 1100 includes monitoring the second Type-1 CSS in the second CORESET as a result of the PRACH being associated with the second CORESET pool index value.

In a fortieth aspect, alone or in combination with one or more of the first through thirty-ninth aspects, the PRACH communication is transmitted from one of a special cell or a secondary cell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with CFRA for intra-cell mTRP communication.

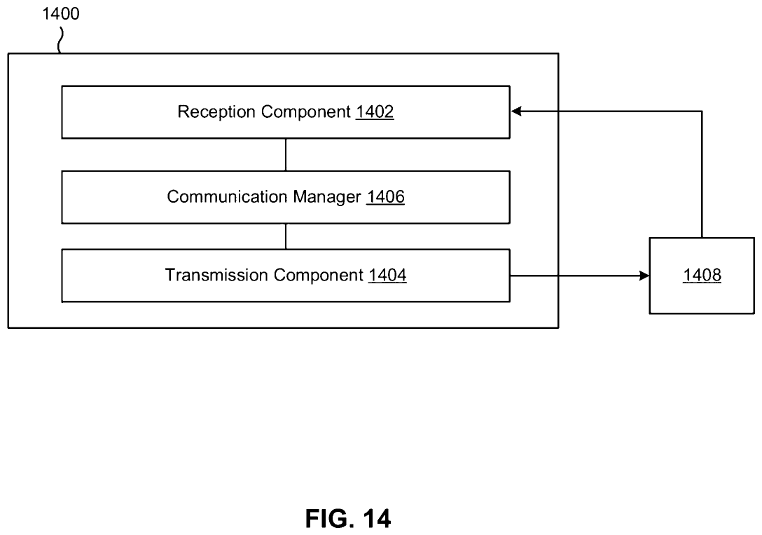

As shown in FIG. 12, in some aspects, process 1200 may include outputting or configuring, to a UE, a PDCCH order associated with a first CORESET pool index value associated with a serving PCI and indicating a PRACH communication (block 1210). For example, the network node (e.g., using transmission component 1404 and/or communication manager 1406, depicted in FIG. 14) may output or configure, to a UE, a PDCCH order associated with a first CORESET pool index value associated with a serving PCI and indicating a PRACH communication, as described above.

As further shown in FIG. 12, in some aspects, process 1200 may include receiving the PRACH communication output by the UE associated with the first CORESET pool index value or a second CORESET pool index value of the serving PCI (block 1220). For example, the network node (e.g., using reception component 1402 and/or communication manager 1406, depicted in FIG. 14) may receive the PRACH communication output by the UE associated with the first CORESET pool index value or a second CORESET pool index value of the serving PCI, as described above.

As further shown in FIG. 12, in some aspects, process 1200 may include outputting or configuring a RAR communication responsive to the PRACH communication and associated with the first CORESET pool index value or the second CORESET pool index value different from the first CORESET pool index value (block 1230). For example, the network node (e.g., using transmission component 1404 and/or communication manager 1406, depicted in FIG. 14) may output or configure a RAR communication responsive to the PRACH communication and associated with the first CORESET pool index value or the second CORESET pool index value different from the first CORESET pool index value, as described above.

As further shown in FIG. 12, in some aspects, process 1200 may include outputting, to the UE, a configuration for the first CORESET pool index value, the second CORESET pool index value, and two TAGs on a serving cell (block 1240). For example, the network node (e.g., using transmission component 1404 and/or communication manager 1406, depicted in FIG. 14) may output, to the UE, a configuration for the first CORESET pool index value, the second CORESET pool index value, and two TAGs on a serving cell, as described above.

Process 1200 may include additional aspects, such as any single aspect or any combination of aspects described below and/or in connection with one or more other processes described elsewhere herein.

In a first aspect, process 1200 includes outputting a configuration for the first CORESET pool index value, the second CORESET pool index value, and two TAGs on a special cell.

In a second aspect, alone or in combination with the first aspect, the PDCCH order is associated with the first CORESET pool index value and indicates the PRACH communication associated with a specific CORESET pool index value, and the RAR communication associated with the second CORESET pool index value is output or configured as a result of the PRACH communication being associated with the specific CORESET pool index value.

In a third aspect, alone or in combination with one or more of the first and second aspects, the specific CORESET pool index value is configured by RRC signaling.

In a fourth aspect, alone or in combination with one or more of the first through third aspects, the specific CORESET pool index value is one of the first CORESET pool index value or the second CORESET pool index value.

In a fifth aspect, alone or in combination with one or more of the first through fourth aspects, process 1200 includes configuring the UE to determine a DMRS antenna port QCL property for the RAR communication, and applying the DMRS based, at least in part, on the PDCCH order being associated with the first CORESET pool index value and the RAR being associated with the second CORESET pool index value.

In a sixth aspect, alone or in combination with one or more of the first through fifth aspects, the DMRS antenna port QCL property is determined, at least in part, from a DL-RS of a TCI state of a CORESET associated with a Type-1 PDCCH CSS set.

In a seventh aspect, alone or in combination with one or more of the first through sixth aspects, the DMRS antenna port QCL property is determined, at least in part, from a DL-RS of an active TCI state of a CORESET with a lowest CORESET identifier associated with a same CORESET pool index value as a CORESET of a Type-1 CSS set.

In an eighth aspect, alone or in combination with one or more of the first through seventh aspects, the DMRS antenna port QCL property is determined, at least in part, from a DL-RS of an active TCI state with a lowest identifier associated with a same CORESET pool index value as a CORESET of a Type-1 CSS set.

In a ninth aspect, alone or in combination with one or more of the first through eighth aspects, the DMRS antenna port QCL property is determined, at least in part, from a DL-RS of a latest-indicated TCI state associated with a same CORESET pool index value as a CORESET of a Type-1 CSS set.

In a tenth aspect, alone or in combination with one or more of the first through ninth aspects, as discussed above, process 1200 includes outputting a configuration for the first CORESET pool index value, the second CORESET pool index value, and two TAGs on a serving cell.

In an eleventh aspect, alone or in combination with one or more of the first through tenth aspects, the PDCCH order is associated with the first CORESET pool index value, and receiving the PRACH communication associated with the second CORESET pool index occurs as a result of the second CORESET pool index value being a fixed value configured by radio resource control signaling.

In a twelfth aspect, alone or in combination with one or more of the first through eleventh aspects, process 1200 includes configuring the UE to determine a PL-RS and a reference signal power for a PRACH transmit power, and applying the PL-RS and reference signal power based, at least in part, on the PDCCH order being associated with the first CORESET pool index value and the PRACH being associated with the second CORESET pool index value.

In a thirteenth aspect, alone or in combination with one or more of the first through twelfth aspects, the PL-RS and the reference signal power for the PRACH transmit power are determined, at least in part, from a DL-RS of an active TCI state with a lowest identifier among one or more TCI states associated with a same CORESET pool index value as the PRACH.

In a fourteenth aspect, alone or in combination with one or more of the first through thirteenth aspects, the PL-RS and the reference signal power for the PRACH transmit power are determined, at least in part, from a DL-RS of an active TCI state of a CORESET having a lowest identifier among one or more CORESETs associated with a same CORESET pool index value as the PRACH.

In a fifteenth aspect, alone or in combination with one or more of the first through fourteenth aspects, the PL-RS and the reference signal power for the PRACH transmit power are determined, at least in part, from a DL-RS of a latest-indicated TCI state associated with a same CORESET pool index value as the PRACH in a unified TCI state.

In a sixteenth aspect, alone or in combination with one or more of the first through fifteenth aspects, the PL-RS and the reference signal power for the PRACH transmit power are determined, at least in part, from a PL-RS of a PUCCH resource with a lowest identifier associated with a same CORESET pool index as the PRACH.

In a seventeenth aspect, alone or in combination with one or more of the first through sixteenth aspects, the PUCCH resource is one of a plurality of PUCCH resources, each associated with one of the first CORESET pool index or the second CORESET pool index.

In an eighteenth aspect, alone or in combination with one or more of the first through seventeenth aspects, the PL-RS and the reference signal power for the PRACH transmit power are determined, at least in part, from an SSB associated with the PRACH communication and indicated by an SSB field in the PDCCH order.

In a nineteenth aspect, alone or in combination with one or more of the first through eighteenth aspects, the PL-RS and the reference signal power for the PRACH transmit power are determined, at least in part, from a DL-RS that is QCLed with an SSB associated with the PRACH communication and indicated by an SSB index field in the PDCCH order.

In a twentieth aspect, alone or in combination with one or more of the first through nineteenth aspects, process 1200 includes outputting a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

In a twenty-first aspect, alone or in combination with one or more of the first through twentieth aspects, process 1200 includes configuring the UE to determine an RAR window based, at least in part, on the first CORESET pool index value and the third CORESET pool index value.

In a twenty-second aspect, alone or in combination with one or more of the first through twenty-first aspects, the RAR window is defined by an RAR window duration and an RAR window start time, wherein the RAR window duration is configured for the serving PCI and the RAR window start time is based, at least in part, on the first CORESET pool index value and the third CORESET pool index value.

In a twenty-third aspect, alone or in combination with one or more of the first through twenty-second aspects, the RAR window start time begins at a first symbol of an earliest CORESET associated with the Type-1 CSS, wherein the first symbol is at least one symbol after a last symbol of a PRACH occasion corresponding to the PRACH communication based, at least in part, on the first CORESET pool index value and the third CORESET pool index value being a same value.

In a twenty-fourth aspect, alone or in combination with one or more of the first through twenty-third aspects, the RAR window start time begins at a first symbol of an earliest CORESET associated with the Type-1 CSS, wherein the first symbol is a predetermined number of symbols or slots, or a predetermined amount of time, after a last symbol of a PRACH occasion corresponding to the PRACH communication based, at least in part, on the first CORESET pool index value and the third CORESET pool index value being different from one another.

In a twenty-fifth aspect, alone or in combination with one or more of the first through twenty-fourth aspects, the RAR window duration is based, at least in part, on the first CORESET pool index value and the third CORESET pool index value being a same value.

In a twenty-sixth aspect, alone or in combination with one or more of the first through twenty-fifth aspects, the RAR window duration corresponds to a first window duration configured using an existing RRC parameter based, at least in part, on the first CORESET pool index value and the third CORESET pool index value being the same value.

In a twenty-seventh aspect, alone or in combination with one or more of the first through twenty-sixth aspects, the RAR window duration is based, at least in part, on a second window duration configured using a new RRC parameter based, at least in part, on the first CORESET pool index value and the third CORESET pool index value being different from one another.

In a twenty-eighth aspect, alone or in combination with one or more of the first through twenty-seventh aspects, the RAR window duration is based, at least in part, on a first window duration plus an extended window duration, wherein the extended window duration is predefined or configured using a new radio resource control parameter.

In a twenty-ninth aspect, alone or in combination with one or more of the first through twenty-eighth aspects, process 1200 includes outputting a configuration for the first CORESET pool index value and the second CORESET pool index value on a special cell, outputting a configuration for a first Type-1 CSS set associated with a first CORESET corresponding to the first CORESET pool index value, and outputting a configuration for a second Type-1 CSS set associated with a second CORESET corresponding to the second CORESET pool index value.

In a thirtieth aspect, alone or in combination with one or more of the first through twenty-ninth aspects, process 1200 includes configuring the UE to determine an RAR window for the PRACH communication associated with one or more of the first CORESET pool index value or the second CORESET pool index value.

In a thirty-first aspect, alone or in combination with one or more of the first through thirtieth aspects, an RAR window duration associated with the RAR window is configured for each of the first CORESET pool index value and the second CORESET pool index value.

In a thirty-second aspect, alone or in combination with one or more of the first through thirty-first aspects, a single RAR window duration is configured for both the first CORESET pool index value and the second CORESET pool index value.

In a thirty-third aspect, alone or in combination with one or more of the first through thirty-second aspects, configuring the UE to determine the RAR window includes configuring the UE to determine that RAR window start time begins at a first symbol of an earliest CORESET of the first CORESET and the second CORESET, wherein the first symbol is at least a predetermined number of symbols after a last symbol of a PRACH occasion corresponding to the PRACH communication.

In a thirty-fourth aspect, alone or in combination with one or more of the first through thirty-third aspects, the RAR window start time is a first symbol of the earliest CORESET associated with the first Type-1 CSS set, wherein the first symbol is at least a predetermined number of symbols after a last symbol of a PRACH occasion corresponding to the PRACH communication based, at least in part, on the PRACH communication being associated with the first CORESET pool index.

In a thirty-fifth aspect, alone or in combination with one or more of the first through thirty-fourth aspects, the RAR window start time is a first symbol of an earliest CORESET associated with the second Type-1 CSS set, wherein the first symbol is at least a predetermined number of symbols after a last symbol of a PRACH occasion corresponding to the PRACH communication based, at least in part, on the PRACH communication being associated with the second CORESET pool index.

In a thirty-sixth aspect, alone or in combination with one or more of the first through thirty-fifth aspects, process 1200 includes configuring the UE to monitor both the first Type-1 CSS in the first CORESET and the second Type-1 CSS in the second CORESET within an RAR window associated with the PRACH communication.

In a thirty-seventh aspect, alone or in combination with one or more of the first through thirty-sixth aspects, configuring the UE to monitor both the first Type-1 CSS in the first CORESET and the second Type-1 CSS in the second CORESET is based, at least in part, on the PRACH communication is associated with a specific CORESET pool index value.

In a thirty-eighth aspect, alone or in combination with one or more of the first through thirty-seventh aspects, process 1200 includes configuring the UE to monitor the first Type-1 CSS in the first CORESET as a result of the PRACH being associated with the first CORESET pool index value.

In a thirty-ninth aspect, alone or in combination with one or more of the first through thirty-eighth aspects, process 1200 includes configuring the UE to monitor the second Type-1 CSS in the second CORESET as a result of the PRACH being associated with the second CORESET pool index value.

In a fortieth aspect, alone or in combination with one or more of the first through thirty-ninth aspects, the PRACH communication is received from one of a special cell or a secondary cell.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-10F. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a configuration for a first CORESET pool index value, a second CORESET pool index value, and two TAGs on a serving cell. The reception component 1302 may receive a PDCCH order associated with the first CORESET pool index value associated with a serving PCI and indicating a PRACH communication. The transmission component 1304 may transmit the PRACH communication associated with the first CORESET pool index value or the second CORESET pool index value associated with the serving PCI in accordance with the PDCCH order. The communication manager 1306 may monitor an RAR communication responsive to the PRACH communication and associated with the first CORESET pool index value or the second CORESET pool index value different from the first CORESET pool index value.

The reception component 1302 may receive a configuration for the first CORESET pool index value, the second CORESET pool index value, and two TAGs on a special cell.

The communication manager 1306 may determine a DMRS antenna port QCL property for the RAR communication.

The communication manager 1306 may apply the DMRS based, at least in part, on the PDCCH order being associated with the first CORESET pool index value and the RAR being associated with the second CORESET pool index value.

The communication manager 1306 may determine a PL-RS and a reference signal power for a PRACH transmit power.

The communication manager 1306 may apply the PL-RS and reference signal power based, at least in part, on the PDCCH order being associated with the first CORESET pool index value and the PRACH being associated with the second CORESET pool index value.

The reception component 1302 may receive a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

The communication manager 1306 may determine an RAR window based, at least in part, on the first CORESET pool index value and the third CORESET pool index value.

The reception component 1302 may receive a configuration for the first CORESET pool index value and the second CORESET pool index value on a special cell The reception component 1302 may receive a configuration for a first Type-1 CSS set associated with a first CORESET corresponding to the first CORESET pool index value.

The reception component 1302 may receive a configuration for a second Type-1 CSS set associated with a second CORESET corresponding to the second CORESET pool index value.

The communication manager 1306 may determine an RAR window for the PRACH communication associated with one or more of the first CORESET pool index value or the second CORESET pool index value.

The communication manager 1306 may monitor both the first Type-1 CSS in the first CORESET and the second Type-1 CSS in the second CORESET within an RAR window associated with the PRACH communication.

The communication manager 1306 may monitor the first Type-1 CSS in the first CORESET as a result of the PRACH being associated with the first CORESET pool index value.

The communication manager 1306 may monitor the second Type-1 CSS in the second CORESET as a result of the PRACH being associated with the second CORESET pool index value.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 4-10F. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may output, to a UE, a configuration for a first CORESET pool index value, a second CORESET pool index value, and two TAGs on a serving cell. The transmission component 1404 may output or configure, to the UE, a PDCCH order associated with the first CORESET pool index value associated with a serving PCI and indicating a PRACH communication. The reception component 1402 may receive the PRACH communication output by the UE associated with the first CORESET pool index value or the second CORESET pool index value of the serving PCI. The transmission component 1404 may output or configure an RAR communication responsive to the PRACH communication and associated with the first CORESET pool index value or the second CORESET pool index value different from the first CORESET pool index value.

The transmission component 1404 may output a configuration for the first CORESET pool index value, the second CORESET pool index value, and two TAGs on a special cell.

The communication manager 1406 may configure the UE to determine a DMRS antenna port QCL property for the RAR communication.

The communication manager 1406 may apply the DMRS based, at least in part, on the PDCCH order being associated with the first CORESET pool index value and the RAR being associated with the second CORESET pool index value.

The communication manager 1406 may configure the UE to determine a PL-RS and a reference signal power for a PRACH transmit power.

The communication manager 1406 may apply the PL-RS and reference signal power based, at least in part, on the PDCCH order being associated with the first CORESET pool index value and the PRACH being associated with the second CORESET pool index value.

The transmission component 1404 may output a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

The communication manager 1406 may configure the UE to determine an RAR window based, at least in part, on the first CORESET pool index value and the third CORESET pool index value.

The transmission component 1404 may output a configuration for the first CORESET pool index value and the second CORESET pool index value on a special cell.

The transmission component 1404 may output a configuration for a first Type-1 CSS set associated with a first CORESET corresponding to the first CORESET pool index value.

The transmission component 1404 may output a configuration for a second Type-1 CSS set associated with a second CORESET corresponding to the second CORESET pool index value.

The communication manager 1406 may configure the UE to determine an RAR window for the PRACH communication associated with one or more of the first CORESET pool index value or the second CORESET pool index value.

The communication manager 1406 may configure the UE to monitor both the first Type-1 CSS in the first CORESET and the second Type-1 CSS in the second CORESET within an RAR window associated with the PRACH communication.

The communication manager 1406 may configure the UE to monitor the first Type-1 CSS in the first CORESET as a result of the PRACH being associated with the first CORESET pool index value.

The communication manager 1406 may configure the UE to monitor the second Type-1 CSS in the second CORESET as a result of the PRACH being associated with the second CORESET pool index value.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving a configuration for a first CORESET pool index value, a second CORESET pool index value, and two timing advance groups on a serving cell; receiving a PDCCH order associated with the first CORESET pool index value associated with a serving PCI and indicating a PRACH communication; and transmitting the PRACH communication associated with the first CORESET pool index value or the second CORESET pool index value associated with the serving PCI in accordance with the PDCCH order.

Aspect 2: The method of Aspect 1, further comprising monitoring an RAR communication responsive to the PRACH communication and associated with the first CORESET pool index value or the second CORESET pool index value different from the first CORESET pool index value.

Aspect 3: The method of Aspect 1, further comprising receiving a configuration for the first CORESET pool index value, the second CORESET pool index value, and two TAGs on a special cell.

Aspect 4: The method of Aspect 1, wherein the PDCCH order is associated with the first CORESET pool index value and indicates the PRACH communication associated with a specific CORESET pool index value, wherein monitoring the RAR communication associated with the second CORESET pool index value occurs as a result of the PRACH communication being associated with the specific CORESET pool index value.

Aspect 5: The method of Aspect 5, wherein the specific CORESET pool index value is configured by RRC signaling.

Aspect 6: The method of Aspect 4, wherein the specific CORESET pool index value is one of the first CORESET pool index value or the second CORESET pool index value.

Aspect 7: The method of Aspect 3, further comprising: determining a DMRS antenna port QCL property for the RAR communication; and applying the DMRS based, at least in part, on the PDCCH order being associated with the first CORESET pool index value and the RAR being associated with the second CORESET pool index value.

Aspect 8: The method of Aspect 7, wherein the DMRS antenna port QCL property is determined, at least in part, from a DL-RS of a TCI state of a CORESET associated with a Type-1 PDCCH CSS set.

Aspect 9: The method of Aspect 7, wherein the DMRS antenna port QCL property is determined, at least in part, from a DL-RS of an active TCI state of a CORESET with a lowest CORESET identifier associated with a same CORESET pool index value as a CORESET of a Type-1 CSS set.

Aspect 10: The method of Aspect 7, wherein the DMRS antenna port QCL property is determined, at least in part, from a DL-RS of an active TCI state with a lowest identifier associated with a same CORESET pool index value as a CORESET of a Type-1 CSS set.

Aspect 11: The method of Aspect 7, wherein the DMRS antenna port QCL property is determined, at least in part, from a DL-RS of a latest-indicated TCI state associated with a same CORESET pool index value as a CORESET of a Type-1 CSS set.

Aspect 12: The method of any of Aspects 1-11, wherein the PDCCH order is associated with the first CORESET pool index value, wherein transmitting the PRACH communication associated with the second CORESET pool index value in accordance with the PDCCH order occurs as a result of the second CORESET pool index value being a fixed value or configured by radio resource control signaling.

Aspect 13: The method of any of Aspects 1-12, further comprising: determining a PL-RS and a reference signal power for a PRACH transmit power; and applying the PL-RS and reference signal power based, at least in part, on the PDCCH order being associated with the first CORESET pool index value and the PRACH being associated with the second CORESET pool index value.

Aspect 14: The method of Aspect 13, wherein the PL-RS and the reference signal power for the PRACH transmit power are determined, at least in part, from a DL-RS of an active TCI state with a lowest identifier among one or more TCI states associated with a same CORESET pool index value as the PRACH.

Aspect 15: The method of Aspect 13, wherein the PL-RS and the reference signal power for the PRACH transmit power are determined, at least in part, from a DL-RS of an active TCI state of a CORESET having a lowest identifier among one or more CORESETs associated with a same CORESET pool index value as the PRACH.

Aspect 16: The method of Aspect 13, wherein the PL-RS and the reference signal power for the PRACH transmit power are determined, at least in part, from a DL-RS of a latest-indicated TCI state associated with a same CORESET pool index value as the PRACH in a unified TCI state.

Aspect 17: The method of Aspect 13, wherein the PL-RS and the reference signal power for the PRACH transmit power are determined, at least in part, from a PL-RS of a PUCCH resource with a lowest identifier associated with a same CORESET pool index as the PRACH.

Aspect 18: The method of Aspect 17, wherein the PUCCH resource is one of a plurality of PUCCH resources, each associated with one of the first CORESET pool index or the second CORESET pool index.

Aspect 19: The method of Aspect 13, wherein the PL-RS and the reference signal power for the PRACH transmit power are determined, at least in part, from an SSB associated with the PRACH communication and indicated by an SSB field in the PDCCH order.

Aspect 20: The method of Aspect 13, wherein the PL-RS and the reference signal power for the PRACH transmit power are determined, at least in part, from a DL-RS that is QCLed with an SSB associated with the PRACH communication and indicated by an SSB index field in the PDCCH order.

Aspect 21: The method of any of Aspects 1-20, further comprising receiving a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

Aspect 22: The method of Aspect 21, further comprising determining an RAR window based, at least in part, on the first CORESET pool index value and the third CORESET pool index value.

Aspect 23: The method of Aspect 22, wherein the RAR window is defined by an RAR window duration and an RAR window start time, wherein the RAR window start time is based, at least in part, on the first CORESET pool index value and the third CORESET pool index value.

Aspect 24: The method of Aspect 23, wherein the RAR window start time begins at a first symbol of an earliest CORESET associated with a Type-1 CSS, wherein the first symbol is at least one symbol after a last symbol of a PRACH occasion corresponding to the PRACH communication based, at least in part, on the first CORESET pool index value and the third CORESET pool index value being a same value.

Aspect 25: The method of Aspect 23, wherein the RAR window start time begins at a first symbol of an earliest CORESET associated with a Type-1 CSS, wherein the first symbol is a predetermined number of symbols or slots, or a predetermined amount of time, after a last symbol of a PRACH occasion corresponding to the PRACH communication based, at least in part, on the first CORESET pool index value and the third CORESET pool index value being different from one another.

Aspect 26: The method of Aspect 23, wherein the RAR window duration is based, at least in part, on the first CORESET pool index value and the third CORESET pool index value.

Aspect 27: The method of Aspect 26, wherein the RAR window duration corresponds to a first window duration configured using an existing RRC parameter based, at least in part, on the first CORESET pool index value and the third CORESET pool index value being a same value.

Aspect 28: The method of Aspect 27, wherein the RAR window duration is based, at least in part, on a second window duration configured using a new RRC parameter based, at least in part, on the first CORESET pool index value and the third CORESET pool index value being different from one another.

Aspect 29: The method of Aspect 26, wherein the RAR window duration is based, at least in part, on a first window duration plus an extended window duration wherein the extended window duration is predefined or configured using a new RRC parameter.

Aspect 30: The method of any of Aspects 1-29, further comprising: receiving a configuration for the first CORESET pool index value and the second CORESET pool index value on a special cell; receiving a configuration for a first Type-1 CSS set associated with a first CORESET corresponding to the first CORESET pool index value; and receiving a configuration for a second Type-1 CSS set associated with a second CORESET corresponding to the second CORESET pool index value.

Aspect 31: The method of Aspect 30, further comprising determining an RAR window for the PRACH communication associated with one or more of the first CORESET pool index value or the second CORESET pool index value.

Aspect 32: The method of Aspect 31, wherein a different RAR window duration is configured for each of the first CORESET pool index value and the second CORESET pool index value.

Aspect 33: The method of Aspect 31, wherein a single RAR window duration is configured for both the first CORESET pool index value and the second CORESET pool index value.

Aspect 34: The method of Aspect 31, wherein determining the RAR window includes determining an RAR window start time, wherein the RAR window start time is a first symbol of an earliest CORESET of the first CORESET and the second CORESET, wherein the first symbol is at least a predetermined number of symbols after a last symbol of a PRACH occasion corresponding to the PRACH communication.

Aspect 35: The method of Aspect 31, wherein the RAR window start time is a first symbol of an earliest CORESET associated with the first Type-1 CSS set, wherein the first symbol is at least a predetermined number of symbols after a last symbol of a PRACH occasion corresponding to the PRACH communication based, at least in part, on the PRACH communication being associated with the first CORESET pool index.

Aspect 36: The method of Aspect 31, wherein the RAR window start time is a first symbol of an earliest CORESET associated with the second Type-1 CSS set, wherein the first symbol is at least a predetermined number of symbols after a last symbol of a PRACH occasion corresponding to the PRACH communication based, at least in part, on the PRACH communication being associated with the second CORESET pool index.

Aspect 37: The method of Aspect 30, further comprising monitoring both the first Type-1 CSS in the first CORESET and the second Type-1 CSS in the second CORESET within an RAR window associated with the PRACH communication.

Aspect 38: The method of Aspect 37, wherein monitoring both the first Type-1 CSS in the first CORESET and the second Type-1 CSS in the second CORESET is based, at least in part, on the PRACH transmission being associated with a specific CORESET pool index value.

Aspect 39: The method of Aspect 30, further comprising monitoring the first Type-1 CSS in the first CORESET as a result of the PRACH being associated with the first CORESET pool index value.

Aspect 40: The method of Aspect 30, further comprising monitoring the second Type-1 CSS in the second CORESET as a result of the PRACH being associated with the second CORESET pool index value.

Aspect 41: The method of any of Aspects 1-40, wherein the PRACH communication is transmitted from one of a special cell or a secondary cell.

Aspect 42: A method of wireless communication performed by a network node, comprising: outputting, to a UE, a configuration for a first CORESET pool index value, a second CORESET pool index value, and two TAGs on a serving cell; outputting, to the UE, a PDCCH order associated with a first CORESET pool index value associated with a serving PCI and indicating a PRACH communication; and receiving the PRACH communication output by the UE associated with the first CORESET pool index value or the second CORESET pool index value of the serving PCI.

Aspect 43: The method of Aspect 42, further comprising outputting a configuration for the first CORESET pool index value, the second CORESET pool index value, and two TAGs on a special cell.

Aspect 44: The method of any of Aspects 42-43, further comprising outputting or configuring an RAR communication responsive to the PRACH communication and associated with the first CORESET pool index value or the second CORESET pool index value different from the first CORESET pool index value.

Aspect 45: The method of Aspect 44, wherein the PDCCH order is associated with the first CORESET pool index value and indicates the PRACH communication associated with a specific CORESET pool index value, wherein the RAR communication associated with the second CORESET pool index value is output or configured as a result of the PRACH communication being associated with the specific CORESET pool index value.

Aspect 46: The method of Aspect 45, wherein the specific CORESET pool index value is configured by RRC signaling.

Aspect 47: The method of Aspect 45, wherein the specific CORESET pool index value is one of the first CORESET pool index value or the second CORESET pool index value.

Aspect 48: The method of Aspect 44, further comprising: configuring the UE to determine a DMRS antenna port QCL property for the RAR communication; and applying the DMRS based, at least in part, on the PDCCH order being associated with the first CORESET pool index value and the RAR being associated with the second CORESET pool index value.

Aspect 49: The method of Aspect 48, wherein the DMRS antenna port QCL property is determined, at least in part, from a DL-RS of a TCI state of a CORESET associated with a Type-1 PDCCH CSS set.

Aspect 50: The method of Aspect 48, wherein the DMRS antenna port QCL property is determined, at least in part, from a DL-RS of an active TCI state of a CORESET with a lowest CORESET identifier associated with a same CORESET pool index value as a CORESET of a Type-I CSS set.

Aspect 51: The method of Aspect 48, wherein the DMRS antenna port QCL property is determined, at least in part, from a DL-RS of an active TCI state with a lowest identifier associated with a same CORESET pool index value as a CORESET of a Type-1 CSS set.

Aspect 52: The method of Aspect 48, wherein the DMRS antenna port QCL property is determined, at least in part, from a DL-RS of a latest-indicated TCI state associated with a same CORESET pool index value as a CORESET of a Type-1 CSS set.

Aspect 53: The method of Aspect 42, wherein the PDCCH order is associated with the first CORESET pool index value, wherein receiving the PRACH communication associated with the second CORESET pool index occurs as a result of the second CORESET pool index value being a fixed value configured by radio resource control signaling.

Aspect 54: The method of any of Aspects 42-53, further comprising configuring the UE to determine a path loss reference signal (PL-RS) and a reference signal power for a PRACH transmit power; and applying the PL-RS and reference signal power based, at least in part, on the PDCCH order being associated with the first CORESET pool index value and the PRACH being associated with the second CORESET pool index value.

Aspect 55: The method of Aspect 54, wherein the PL-RS and the reference signal power for the PRACH transmit power are determined, at least in part, from a DL-RS of an active TCI state with a lowest identifier among one or more TCI states associated with a same CORESET pool index value as the PRACH.

Aspect 56: The method of Aspect 54, wherein the PL-RS and the reference signal power for the PRACH transmit power are determined, at least in part, from a DL-RS of an active TCI state of a CORESET having a lowest identifier among one or more CORESETs associated with a same CORESET pool index value as the PRACH.

Aspect 57: The method of Aspect 54, wherein the PL-RS and the reference signal power for the PRACH transmit power are determined, at least in part, from a DL-RS of a latest-indicated TCI state associated with a same CORESET pool index value as the PRACH in a unified TCI state.

Aspect 58: The method of Aspect 54, wherein the PL-RS and the reference signal power for the PRACH transmit power are determined, at least in part, from a PL-RS of a PUCCH resource with a lowest identifier associated with a same CORESET pool index as the PRACH.

Aspect 59: The method of Aspect 58, wherein the PUCCH resource is one of a plurality of PUCCH resources, each associated with one of the first CORESET pool index or the second CORESET pool index.

Aspect 60: The method of Aspect 54, wherein the PL-RS and the reference signal power for the PRACH transmit power are determined, at least in part, from an SSB associated with the PRACH communication and indicated by an SSB field in the PDCCH order.

Aspect 61: The method of Aspect 54, wherein the PL-RS and the reference signal power for the PRACH transmit power are determined, at least in part, from a DL-RS that is QCLed with an SSB associated with the PRACH communication and indicated by an SSB index field in the PDCCH order.

Aspect 62: The method of any of Aspects 42-61, further comprising outputting a Type-1 CSS configuration associated with a third CORESET pool index value on a serving cell, wherein the PDCCH order is associated with the first CORESET pool index or the second CORESET pool index and indicates transmission of the PRACH associated with the first CORESET pool index value on the serving cell.

Aspect 63: The method of Aspect 62, further comprising configuring the UE to determine an RAR window based, at least in part, on the first CORESET pool index value and the third CORESET pool index value.

Aspect 64: The method of Aspect 63, wherein the RAR window is defined by an RAR window duration and an RAR window start time, wherein the RAR window duration is configured for the serving PCI and the RAR window start time is based, at least in part, on the first CORESET pool index value and the third CORESET pool index value.

Aspect 65: The method of Aspect 64, wherein the RAR window start time begins at a first symbol of an earliest CORESET associated with the Type-1 CSS, wherein the first symbol is at least one symbol after a last symbol of a PRACH occasion corresponding to the PRACH communication based, at least in part, on the first CORESET pool index value and the third CORESET pool index value being a same value.

Aspect 66: The method of Aspect 64, wherein the RAR window start time begins at a first symbol of an earliest CORESET associated with the Type-1 CSS, wherein the first symbol is a predetermined number of symbols or slots, or a predetermined amount of time, after a last symbol of a PRACH occasion corresponding to the PRACH communication based, at least in part, on the first CORESET pool index value and the third CORESET pool index value being different from one another.

Aspect 67: The method of Aspect 64, wherein the RAR window duration is based, at least in part, on the first CORESET pool index value and the third CORESET pool index value being a same value.

Aspect 68: The method of Aspect 67, wherein the RAR window duration corresponds to a first window duration configured using an existing RRC parameter based, at least in part, on the first CORESET pool index value and the third CORESET pool index value being the same value.

Aspect 69: The method of Aspect 68, wherein the RAR window duration is based, at least in part, on a second window duration configured using a new RRC parameter based, at least in part, on the first CORESET pool index value and the third CORESET pool index value being different from one another.

Aspect 70: The method of Aspect 67, wherein the RAR window duration is based, at least in part, on a first window duration plus an extended window duration, wherein the extended window duration is predefined or configured using a new radio resource control parameter.

Aspect 71: The method of any of Aspects 42-70, further comprising: outputting a configuration for the first CORESET pool index value and the second CORESET pool index value on a special cell; outputting a configuration for a first Type-1 CSS set associated with a first CORESET corresponding to the first CORESET pool index value; and outputting a configuration for a second Type-1 CSS set associated with a second CORESET corresponding to the second CORESET pool index value.

Aspect 72: The method of Aspect 71, further comprising configuring the UE to determine an RAR window for the PRACH communication associated with one or more of the first CORESET pool index value or the second CORESET pool index value.

Aspect 73: The method of Aspect 72, wherein an RAR window duration associated with the RAR window is configured for each of the first CORESET pool index value and the second CORESET pool index value.

Aspect 74: The method of Aspect 72, wherein a single RAR window duration is configured for both the first CORESET pool index value and the second CORESET pool index value.

Aspect 75: The method of Aspect 72, wherein configuring the UE to determine the RAR window includes configuring the UE to determine that RAR window start time begins at a first symbol of an earliest CORESET of the first CORESET and the second CORESET, wherein the first symbol is at least a predetermined number of symbols after a last symbol of a PRACH occasion corresponding to the PRACH communication.

Aspect 76: The method of Aspect 72, wherein the RAR window start time is a first symbol of the earliest CORESET associated with the first Type-1 CSS set, wherein the first symbol is at least a predetermined number of symbols after a last symbol of a PRACH occasion corresponding to the PRACH communication based, at least in part, on the PRACH communication being associated with the first CORESET pool index.

Aspect 77: The method of Aspect 72, wherein the RAR window start time is a first symbol of an earliest CORESET associated with the second Type-1 CSS set, wherein the first symbol is at least a predetermined number of symbols after a last symbol of a PRACH occasion corresponding to the PRACH communication based, at least in part, on the PRACH communication being associated with the second CORESET pool index.

Aspect 78: The method of Aspect 71, further comprising configuring the UE to monitor both the first Type-1 CSS in the first CORESET and the second Type-1 CSS in the second CORESET within an RAR window associated with the PRACH communication.

Aspect 79: The method of Aspect 78, wherein configuring the UE to monitor both the first Type-1 CSS in the first CORESET and the second Type-1 CSS in the second CORESET is based, at least in part, on the PRACH communication is associated with a specific CORESET pool index value.

Aspect 80: The method of Aspect 71, further comprising configuring the UE to monitor the first Type-1 CSS in the first CORESET as a result of the PRACH being associated with the first CORESET pool index value.

Aspect 81: The method of Aspect 71, further comprising configuring the UE to monitor the second Type-1 CSS in the second CORESET as a result of the PRACH being associated with the second CORESET pool index value.

Aspect 82: The method of any of Aspects 42-81, wherein the PRACH communication is received from one of a special cell or a secondary cell.

Aspect 83: An apparatus for wireless communication at a device, comprising a processor; memory coupled with the processor; and instructions stored in the memory and executable by the processor to cause the apparatus to perform the method of one or more of Aspects 1-82.

Aspect 84: A device for wireless communication, comprising a memory and one or more processors coupled to the memory, the one or more processors configured to perform the method of one or more of Aspects 1-82.

Aspect 85: An apparatus for wireless communication, comprising at least one means for performing the method of one or more of Aspects 1-82.

Aspect 86: A non-transitory computer-readable medium storing code for wireless communication, the code comprising instructions executable by a processor to perform the method of one or more of Aspects 1-82.

Aspect 87: A non-transitory computer-readable medium storing a set of instructions for wireless communication, the set of instructions comprising one or more instructions that, when executed by one or more processors of a device, cause the device to perform the method of one or more of Aspects 1-82.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
receive a configuration for a first control resource set (CORESET) pool index value, a second CORESET pool index value, and two timing advance groups on a serving cell;
receive a physical downlink control channel (PDCCH) order associated with the first CORESET pool index value associated with a serving physical cell identifier (PCI) and indicating a physical random access channel (PRACH) communication; and
transmit the PRACH communication associated with the first CORESET pool index value or the second CORESET pool index value associated with the serving PCI in accordance with the PDCCH order.

2. The UE of claim 1, wherein the PDCCH order is associated with the first CORESET pool index value.

3. The UE of claim 1, wherein the one or more processors are configured to transmit the PRACH communication associated with the second CORESET pool index value in accordance with the PDCCH order as a result of the second CORESET pool index value being a fixed value or being configured by radio resource control signaling.

4. The UE of claim 1, wherein the one or more processors are further configured to determine a path loss reference signal (PL-RS) and a reference signal power for a PRACH transmit power.

5. The UE of claim 4, wherein the one or more processors are further configured to apply the PL-RS and the reference signal power based, at least in part, on the PDCCH order being associated with the first CORESET pool index value and the PRACH being associated with the second CORESET pool index value.

6. The UE of claim 5, wherein the one or more processors are further configured to determine the PL-RS and the reference signal power for the PRACH transmit power from a synchronization signal block (SSB).

7. The UE of claim 6, wherein the SSB is associated with the PRACH communication and indicated by an SSB field in the PDCCH order.

8. The UE of claim 1, wherein the first CORESET pool index value is CORESETPoolIndex 0 or CORESETPoolIndex 1.

9. (canceled)

10. A network node for wireless communication, comprising:
one or more memories; and
one or more processors, coupled to the one or more memories, configured to:
output, to a user equipment (UE), a configuration for a first control resource set (CORESET) pool index value, a second CORESET pool index value, and two timing advance groups on a serving cell;
output, to the UE, a physical downlink control channel (PDCCH) order associated with the first CORESET pool index value associated with a serving physical cell identifier (PCI) and indicating a physical random access channel (PRACH) communication; and
receive the PRACH communication output by the UE associated with the first CORESET pool index value or the second CORESET pool index value of the serving PCI.

11. The network node of claim 10, wherein the PDCCH order is associated with the first CORESET pool index value.

12. The network node of claim 10, wherein the one or more processors are configured to receive the PRACH communication associated with the second CORESET pool index value in accordance with the PDCCH order as a result of the second CORESET pool index value being a fixed value or being configured by radio resource control signaling.

13. The network node of claim 10, wherein the configuration for the first CORESET pool index value, the second CORESET pool index value, and two timing advance groups on a serving cell includes a configuration for the UE to determine a path loss reference signal (PL-RS) and a reference signal power for a PRACH transmit power.

14. The network node of claim 13, wherein the one or more processors are further configured to configure the UE to apply the PL-RS and the reference signal power based, at least in part, on the PDCCH order being associated with the first CORESET pool index value and the PRACH being associated with the second CORESET pool index value.

15-16. (canceled)

17. The network node of claim 10, wherein the first CORESET pool index value is CORESETPoolIndex 0 or CORESETPoolIndex 1.

18. (canceled)

19. A method of wireless communication performed by a user equipment (UE), comprising:
receiving a configuration for a first control resource set (CORESET) pool index value, a second CORESET pool index value, and two timing advance groups on a serving cell;
receiving a physical downlink control channel (PDCCH) order associated with the first CORESET pool index value associated with a serving physical cell identifier (PCI) and indicating a physical random access channel (PRACH) communication; and
transmitting the PRACH communication associated with the first CORESET pool index value or the second CORESET pool index value associated with the serving PCI in accordance with the PDCCH order.

20. The method of claim 19, wherein the PDCCH order is associated with the first CORESET pool index value.

21. The method of claim 19, wherein transmitting the PRACH communication associated with the second CORESET pool index value in accordance with the PDCCH order occurs as a result of the second CORESET pool index value being a fixed value or being configured by radio resource control signaling.

22. The method of claim 19, further comprising determining a path loss reference signal (PL-RS) and a reference signal power for a PRACH transmit power.

23. The method of claim 22, further comprising applying the PL-RS and the reference signal power based, at least in part, on the PDCCH order being associated with the first CORESET pool index value and the PRACH being associated with the second CORESET pool index value.

24. The method of claim 23, further comprising determining the PL-RS and the reference signal power for the PRACH transmit power from a synchronization signal block (SSB).

25-30. (canceled)
